(19) United States
(12) Patent Application Publication
(10) Pub. No.: US 2010/0182799 A1
(43) Pub. Date: Jul. 22, 2010

(54) Planar light-emitting device, panel and display device

(75) Inventor: Makoto Tanahashi, Kanagawa (JP)

Correspondence Address: LERNER, DAVID, LITTENBERG,;KRUMHOLZ & MENTLIK, 600 SOUTH AVENUE WEST, WESTFIELD, NJ, 07090, US

(73) Assignee: Sony Corporation, Tokyo (JP)

(21) Appl. No.: 12/657,066

(22) Filed: Jan. 13, 2010

(30) Foreign Application Priority Data
Jan. 16, 2009 (JP) P2009-007222

(51) Int. Cl. F21V 7/04

(52) U.S. Cl. 362/606; 362/611; 362/612

(57) ABSTRACT

A planar light-emitting device includes: a light source; and a light guide member propagating light from the light source, wherein the light guide member is formed so that a light entrance portion on which light from the light source is incident is thicker than a body portion, and the light source includes a light-emitting member and a directivity member narrowing the directivity of light emitted from the light emitting member and allowing the light to be incident on the light entrance portion of the light guide member.

### BACKGROUND OF THE INVENTION

1. Field of the Invention

The present invention relates to a planar light-emitting device, a panel, and a display device, and particularly relates to a planar light-emitting device, a panel, and a display device capable of realizing a thinner and lighter liquid crystal display device.

2. Description of the Related Art

In recent years, a liquid crystal display device is becoming popular. The liquid crystal display device displays images by controlling light transmittance incident on a liquid crystal panel thereof by each pixel. Therefore, a backlight for allowing light to be incident on the liquid crystal panel is incorporated in the liquid crystal panel in many cases (for example, see JP-A-Hei-11-174976 (Patent Document 1), JP-A-2004-12747 (Patent Document 2) and JP-A-2004-335405 (Patent Document 3)).

### SUMMARY OF THE INVENTION

However, in the backlight of related art, it is sometimes difficult to reduce the thickness of a light guide plate used for the backlight. Thus, it is demanded to reduce the light guide plate for making the liquid crystal display device thinner in thickness and lighter in weight, however, it is difficult to sufficiently respond to the demand in the circumstances.

Thus, it is desirable to realize the thinner and lighter liquid crystal display device.

According to an embodiment of the invention, there is provided a planar light-emitting device including a light source and a light guide member propagating light from the light source, in which the light guide member is formed so that a light entrance portion on which light from the light source is incident is thicker than a body portion, and the light source includes a light-emitting member and a directivity member narrowing the directivity of light emitted from the light emitting member and allowing the light to be incident on the light entrance portion of the light guide member.

The directivity member of the light source may have a lens function.

The lens function may be a function of a convex lens or a prism lens.

The light source may include an LED (Light Emitting Diode), an LED semiconductor chip of the LED may be included as the light-emitting member and component members other than the LED semiconductor chip of the LED constitute the directivity member.

In the planar light-emitting device according to the embodiment of the invention, a light source and a light guide member propagating light from the light source may be provided. The light guide member may be formed so that a light entrance portion on which light from the light source is incident is thicker than a body portion. The directivity of light emitted from a light-emitting member by the light source may be narrowed through a directivity member, and the light may be incident on the light entrance portion of the light guide member.

According to another embodiment of the invention, there is provided a panel including a backlight having a light source and a light guide member propagating light from the light source, and a display unit displaying images by using light incident from the backlight, in which the light guide member is formed so that a light entrance portion on which light from the light source is incident is thicker than a body portion and the light source includes a light-emitting member and a directivity member narrowing the directivity of light emitted from the light emitting member and allowing the light to be incident on the light entrance portion of the light guide member.

In the panel according to the embodiment of the invention, a backlight having a light source and a light guide member propagating light from the light source, and a display unit displaying images by using light incident from the backlight may be included. The light guide member may be formed so that a light entrance portion on which light from the light source is incident is thicker than a body portion. The directivity of light emitted from a light-emitting member by the light source may be narrowed by a directivity member, and the light may be incident on the light entrance portion of the light guide member.

According to still another embodiment of the invention, there is provided a display device including a backlight including a light source and a light guide member propagating light from the light source, and a panel including a display unit displaying images by using light incident from the backlight, in which the light guide member is formed so that a light entrance portion on which light from the light source is incident is thicker than a body portion, and the light source includes a light-emitting member and a directivity member narrowing the directivity of light emitted from the light emitting member and allowing the light to be incident on the light entrance portion of the light guide member.

In the display device according to the embodiment of the invention, a backlight having a light source and a light guide member propagating light from the light source, and a panel including a display unit displaying images by using light incident from the backlight may be included. The light guide member may be formed so that a light entrance portion on which light from the light source may be incident is thicker than a body portion. The directivity of light emitted from a light-emitting member by the light source may be narrowed by a directivity member, and the light may be incident on the light entrance portion of the light guide member.

According to the embodiments of the invention, for example, when a liquid crystal display device is applied as the display device, it becomes possible to allow the liquid crystal display device to thinner in thickness and lighter in weight.

### BRIEF DESCRIPTION OF THE DRAWINGS

FIG. 1 is a view showing a configuration example of a backlight of related art applying a lamp as a light source in liquid crystal display devices used for, for example, a notebook personal computer;

FIG. 2 is a view showing a configuration example of a backlight of related art applying LEDs as a light source in liquid crystal display devices used for, for example, a notebook personal computer;

FIG. 3A and FIG. 3B are cross-sectional views of a light guide plate 2;

FIG. 4A and FIG. 4B are views showing the relation between an incident angle and a refractive angle of light;

FIG. 5 is a graph showing the relation between an angle α and an angle β;

FIG. 6 is a view for explaining a critical angle;

FIG. 7 is a view showing how light from a light source is guided in the light guide plate 2;

FIG. 8 is a view showing how the light from the light source is guided when the trumpet angle θ of the light guide plate 2 is 2 deg;

FIG. 9 is a view showing how the light from the light source is guided when the trumpet angle θ of the light guide plate 2 is 3 deg;

FIG. 10 is a view showing how the light from the light source is guided when the trumpet angle θ of the light guide plate 2 is 6 deg;

FIG. 11 is a view showing how the light from the light source is guided when the trumpet angle θ of the light guide plate 2 is 8 deg;

FIG. 12 is a view showing the relation between a length “L” of a trumpet portion and the number of repeated reflections;

FIG. 13 is a view showing the relation between a length “L” of a trumpet portion and the number of repeated reflections;

FIG. 14 is a view showing how the light from the light source is guided in the case that a light incident angle β from the light source to the light guide plate 2 is 70 deg and the trumpet angle θ of the light guide plate 2 is 3 deg;

FIG. 15 is a view showing how the light from the light source is guided in the case that a light incident angle β from the light source to the light guide plate 2 is 0 deg and the trumpet angle θ of the light guide plate 2 is 6 deg;

FIG. 16 is a graph showing the relation between the light incident angle β from the light source and incident angles “b” to “g” of the upper surface 2c or the lower surface 2b inside the light guide plate 2 in the case that the trumpet angle θ of the light guide plate 2 is 3 deg;

FIG. 17 is a graph showing the relation between the light incident angle β from the light source and incident angles “b” to “g” of the upper surface 2c or the lower surface 2b inside the light guide plate 2 in the case that the trumpet angle θ of the light guide plate 2 is 9 deg;

FIG. 18 is a graph showing the relation between the trumpet angle θ and the first to the sixth light incident angles “b” to “g” inside the light guide plate 2 when the light incident angle β from the light source is 0 deg;

FIG. 19 is a graph showing the relation between the trumpet angle θ and the first to the sixth light incident angles “b” to “g” inside the light guide plate 2 when the light incident angle β from the light source is 40 deg;

FIG. 20A and FIG. 20B are view showing examples of directivity of light from the light source;

FIG. 21A and FIG. 21B are views showing configuration examples of a portion including a light source of one embodiment of the invention and the light guide plate 2 in the backlight having the configuration of FIG. 2;

FIG. 22A to FIG. 22E are perspective views showing various examples of the light source 41 configured to have one lens sheet 21 arranged with respect to plural LEDs 14;

FIG. 23A to FIG. 23D are perspective views showing various examples of the light source 41 configured to have one lens sheet 21 arranged with respect to one LED 14;

FIG. 24A to FIG. 24D are perspective view showing various examples of the light source 41 in the case that the LED 14 and the lens sheet 21 are integrated by applying the lens sheet 21 to resin forming one LED 14;

FIG. 25 is a view showing the directivity of light of the LED 14 as the light source 31 of related art;

FIG. 26 is a view showing the directivity of light of the light source 41 of one embodiment of the invention, which is formed by arranging the lens sheet 21 in front of the LED 14;

FIG. 27 is a perspective view showing an example of the light source 41 configured by applying an LED semiconductor chip 52 as the light emitting member and a sealant 51 having the lens function as the directivity member;

FIG. 28A to FIG. 28D are cross-sectional views showing side surfaces of the light source 41 of the example of FIG. 26; and

FIG. 29A to FIG. 29D are cross-sectional views showing respective light guide plate 2 including various shapes of the trumpet portions.

### DESCRIPTION OF THE PREFERRED EMBODIMENTS

In order to make the understanding of the invention easier, a backlight in related art will be explained first. As a light source, a lamp and an LED (Light Emitting Diode) are chiefly used in many cases. Hereinafter, configuration examples of backlights of related art will be explained, which apply a lamp and an LED as light sources respectively.

### 1. Configuration Example of a Backlight of Related Art

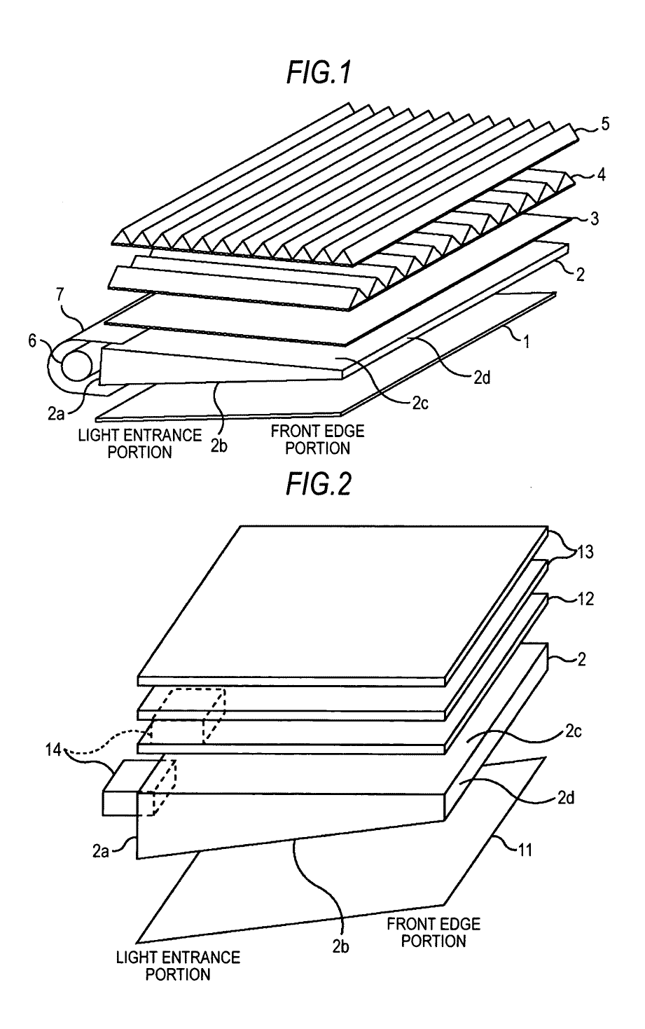

FIG. 1 is a view showing a configuration example of a backlight of related art applying a lamp as a light source in liquid crystal display devices used for, for example, a notebook personal computer.

A backlight shown in FIG. 1 includes a reflector plate 1, a light guide plate 2, a diffusion sheet 3, a vertical prism sheet 4, a horizontal prism sheet 5, a cold cathode tube 6 and a reflector 7.

In FIG. 1, a portion on a side surface 2a side at the left side in the drawing where the light source is arranged in a lower surface 2b, an upper surface 2c and the inside between them of the light guide plate 2 will be referred to as a light entrance portion in the following description. On the other hand, a portion on a side surface 2d side opposed to the side surface 2a, that is, the portion on the side surface 2d side at the right side in the drawing in the lower surface 2b, the upper surface 2c and the inside between them of the light guide plate 2 will be referred to as a front edge portion.

The light guide plate 2 in the example of FIG. 1 has a so-called wedge shape. The cold cathode tube 6 having the reflector 7 is arranged close to the side surface 2a of the light guide plate 2 as a light source. That is, light from the light source is guided from the light entrance portion inside the light guide plate 2 to the front edge portion.

On the lower surface 2b in surfaces orthogonal to the side surface 2a of the light guide plate 2 (lower surface 2b at a lower position of FIG. 1), the reflector plate 1 is arranged. On the upper surface 2c opposed to the lower surface 2b of the light guide plate 2, the diffusion sheet 3 is disposed for reducing luminance unevenness. Further, at an upper direction of the diffusion sheet 3 in FIG. 1, the vertical prism sheet 4 and the horizontal prism sheet 5 are stacked from the lower layer in the above order for improve luminance. The vertical prism sheet 4 and the horizontal prism sheet 5 are stacked so that ridges of the prisms are orthogonal to each other.

FIG. 2 is a view showing a configuration example of the backlight of related art which uses an LED as a light source in liquid crystal display devices used for, for example, a notebook personal computer.

The backlight shown in FIG. 2 is configured to include a reflection sheet 11, the light guide plate 2, a diffusion film 12, prism sheets 13 and LEDs 14.

The light guide plate 2 of the example of FIG. 2 also has a wedge shape. The LEDs 14 are arranged close to the side surface 2a of the light guide plate 2 as light sources. Light from light sources is guided from the light entrance portion inside the light guide plate 2 to the front edge portion.

On the lower surface 2b side of the light guide plate 2, the reflection sheet 11 is disposed. On the upper surface 2c side of the light guide plate 2, the diffusion film 12 is arranged for reducing luminance unevenness. Further, at an upper direction of the diffusion film 12 in FIG. 2, the prism sheets 13 are arranged for improving luminance.

As described above, the shape of the light guide plate 2 has the wedge shape in examples of FIG. 1 and FIG. 2. However, the shape of the light guide plate 2 is not limited to the wedge shape. Hereinafter, the shape of the light guide plate will be explained.

### 2. Examples of the Shape of the Light Guide Plate

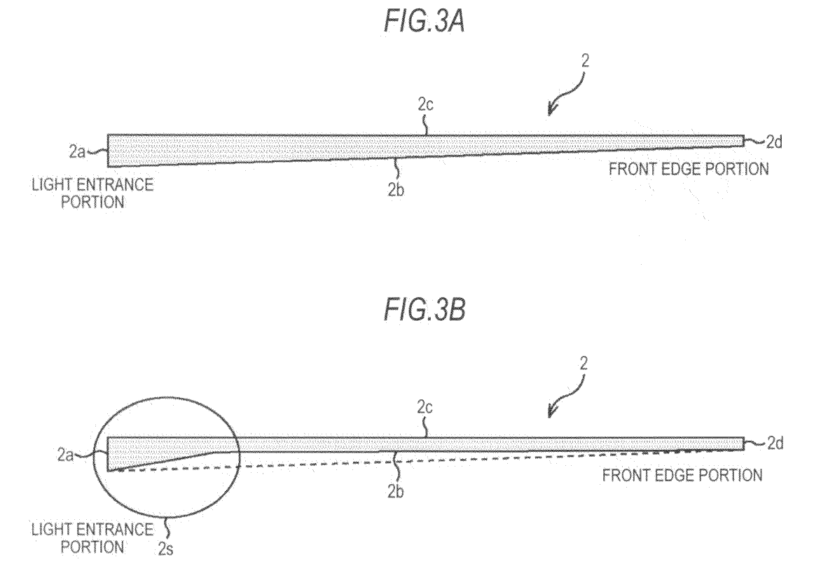

FIG. 3A and FIG. 3B show cross-sectional views of the light guide plate 2.

FIG. 3A shows a cross-sectional view of the light guide plate 2 having the wedge shape shown in FIG. 1 and FIG. 2. That is, the light guide plate 2 of the example of FIG. 3A has a so-called wedge shape in which the light guide plate 2 is thick at the side surface 2a of the light entrance portion and becomes thinner toward the side surface 2d of the front edge portion.

It is not inevitably necessary that the light guide plate 2 has the wedge shape as described above. For example, even though the light guide plate 2 is a flat plate shape having a fixed thickness, the light guide plate 2 can exert a function of diffusing light from the light source on the surface of the backlight to uniform the luminance. However, when the shape of the light guide plate 2 is made to be the wedge shape, the light guide plate 2 can be made lighter in weight and can save material for the plate as compared with the light guide plate of the flat plate having the fixed thickness. Moreover, the front edge portion of the light guide plate 2 is thinner, therefore, it is possible to dispose a drive circuit of a display unit of the liquid crystal display device at the thin portion, which allows the entire liquid crystal display device to be thinner.

However, when considering the thickness of the light guide plate 2, it is difficult to allow the liquid crystal display device to be further thinner in thickness and lighter in weight by the simple wedge shape. It is because of the relation between the light guide plate 2 and the cold cathode tube 6 or the LED 14 as the light source. That is, when the size (thickness) of the side surface 2a of the light entrance portion (referred to as a light entrance surface 2a in the following description) of the light guide plate 2 is smaller than the size (thickness) of the cold cathode tube 6 or the LED 14 as the light source, the light entrance rate of light entering from the light source to the light guide plate 2 is reduced. Therefore, the size of the light entrance surface 2a of the light guide plate 2 is commonly set to the size which is equal to or larger than the size of the cold cathode tube 6 or the LED 14 as the light source.

As described above, it is difficult to reduce the size of the light entrance surface 2a to be the size less than the fixed size, therefore, when the simple wedge shape is applied as the shape of the light guide plate 2, it was difficult to allow the liquid crystal display device to be further thinner in thickness and lighter in weight.

Accordingly, the light guide plate 2 having the shape obtained by improving the wedge shape as shown in FIG. 3B is disclosed in the Patent Documents 2 and 3. Such shape of the light guide plate 2 is applied, thereby allowing the liquid crystal display device to further thinner and lighter.

FIG. 3B shows a cross-sectional view of the light guide plate 2 having a so-called trumpet shape.

In the light guide plate 2 in the example of FIG. 3B, an inclination angle (referred to as a trumpet angle in the following description) of the lower surface 2b in a portion near the light entrance portion 2s is set to be larger than the light guide plate 2 of the example of FIG. 3A. Also in the light guide plate 2 of the example of FIG. 3B, the light entrance surface 2a secures the size equal to or more than the size of the cold cathode tube 6 or the LED 14 as the light source.

The light guide plate 2 of the example of FIG. 3B, namely, the light guide plate 2 securing the trumpet angle is applied to the backlight for a portable phone device or a notebook personal computer. However, when the trumpet angle of the light angle plate 2 is set to be too large, light entering into the light guide plate 2 escapes out of the light guide plate 2 on the way and the utilization ratio of light may be reduced (for example, see Patent Document 2)

Accordingly, it is necessary to set the trumpet angle and the like of the light guide plate 2 in a range in which light entering into the light guide plate 2 does not escape out of the light guide plate 2 on the way. Accordingly, it is necessary to consider whether light entering into the light guide plate 2 escapes out of the light guide plate 2 on the way or not. In order to perform the consideration easily, in what manner light is guided into the light guide plate 2 will be explained as background art. Assume that a material of the light guide plate 2 is acrylic in the following description.

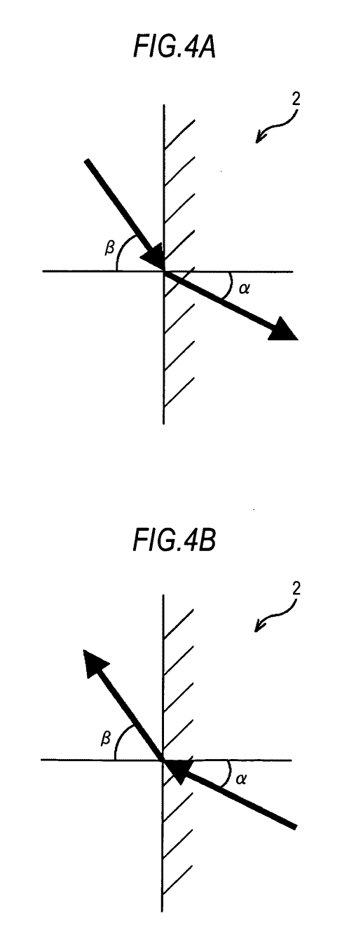

FIG. 4A and FIG. 4B are views showing the relation between an incident angle and a refracting angle of light.

In FIG. 4A and FIG. 4B, light is shown by arrows. In each drawing, a hatched region on the right side of the drawing with respect to a border line of the vertical direction in the drawing which passes through an intersection of two arrows shows the inside of the light guide plate 2 having the acrylic material, and a hatched region on the left side of the drawing shows an air region. This precondition is the same in other drawings.

FIG. 4A shows the relation between the incident angle and the refracting angle of light when light is incident from the air region toward the light guide plate 2.

In the case of FIG. 4A, an angle β represents the incident angle and an angle α represents the refracting angle.

FIG. 4B shows the relation between the incident angle and the refracting angle of light when light is emitted from the light guide plate 2 to the air region.

In the case of FIG. 4B, an angle α represents the incident angle and an angle β represents the refracting angle.

A refractive index “n” can be represented by the following equation (1) according to Snell's law.

n=sin β/sin α (1)

When the equation (1) is solved for the angle α, the angle α can be represented as the following equation (2).

α=a sin(sin β/n) (2)

In the equation (2), “a sin” represents an arcsine. This is the same in the following equations.

The refractive index “n” of light in the air region and in the light guide plate 2 is almost 1.49, therefore, the equation (2) can be represented as the following equation (3).

α=a sin(sin β/1.49) (3)

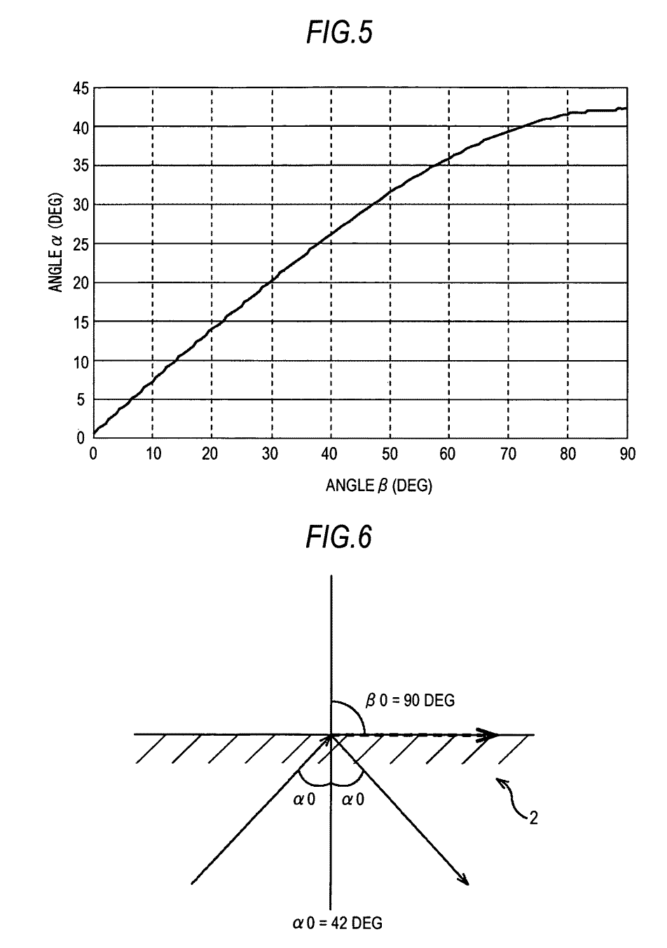

FIG. 5 is a graph representing the equation (3), namely, the graph representing the relation between the angle α and the angle β.

In FIG. 5, the vertical axis represents the angle α and the horizontal axis represents the angle β. It can be seen that the angle α becomes larger in proportion as the angle β becomes larger. Here, the incident angle α at which the refracting angle β becomes 90 deg in FIG. 4B is referred to as a critical angle. When “the refractive angle β=90 deg” is substituted into the equation (1), the critical angle becomes 42 deg. The critical angle will be explained with reference to FIG. 6.

FIG. 6 is a view for explaining the critical angle.

As shown by an arrow on the left side of FIG. 6, assume that light is incident on the side surface of the light guide plate 2 (an interface with respect to the air region) from the inside thereof at the critical angle of the incident angle α0=42 deg. In this case, as shown by a dotted arrow on the right side, the refractive angle will be β0=90 deg, therefore, light does not escape out of the light guide plate 2. Therefore, light guided inside the light guide plate 2 is totally reflected at a reflection angle α0 when light is incident on the side surface (interface with respect to the air region) of the light guide plate 2 at an angle equal to or larger than the critical angle of the incident angle α0=42 deg. That is, light entering into the light guide plate 2 from the light source is guided inside the light guide plate 2 when the incident angle α0 is equal to or larger than 42 deg as the critical angle with respect to the side surface (interface with respect to the air region). On the other hand, specifically, when the incident angle α is smaller than 42 deg, part of incident light escapes out of the light guide plate 2, which reduces light guiding efficiency of the light guide plate 2.

Hereinafter, the light guide plate 2 of the example of FIG. 3B, namely, how light entering into the light guide plate 2 having the large trumpet angle is guided inside the light guide plate 2 will be explained.

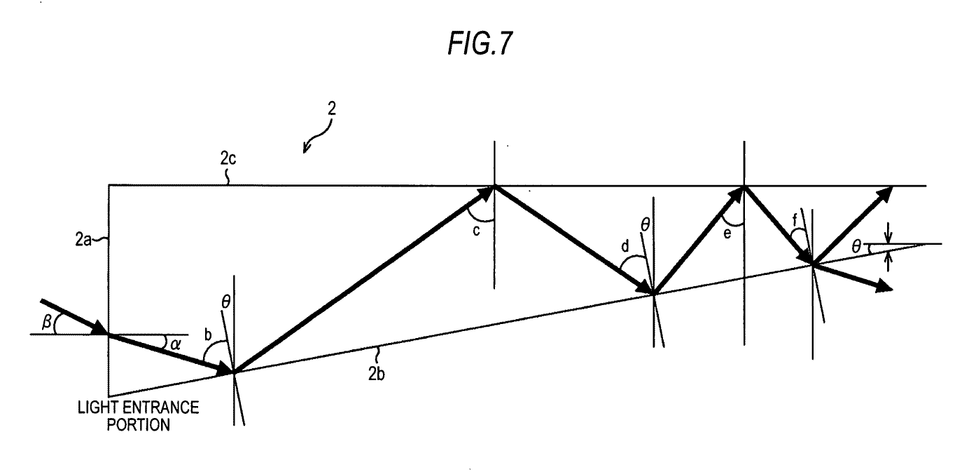

FIG. 7 is a view showing how the light from the light source is guided inside the light guide plate 2.

In FIG. 7, the trumpet angle is represented by θ. In the example of FIG. 7, only a part in the vicinity of the light entrance surface 2a in the light guide plate 2 is shown. Assume that the incident angle of light entering into the light guide plate 2 from the light entrance surface 2a is β, and the refractive angle inside the light guide plate 2 is α. Light entering from the light entrance surface 2 is guided while being reflected on the upper surface 2c and the lower surface 2b plural times.

When light incident angles are written in a manner that the first incident angle is “b”, the second incident angle is “c”, the third incident angle is “d” and so on, the relation of the incident angles “b”, “c” and “d”, the trumpet angle θ and the refracting angle α will be represented as the following equations (4).

b=90−α−θ

c=90−α−2θ

d=90−α−3θ

e=90−α−4θ

f=90−α−5θ (4)

When the right side of the equation (3) is substituted into the refractive angle α of the equations (4), incident angles b, c, d . . . can be calculated.

For example, when the trumpet angle θ of the light guide plate 2 is 3 deg, the right side of the equation (3) is substituted into the refractive angle α of the equations (4), the first light incident angle “b” can be represented by the following equation (5).

$$\begin{matrix}b = 90 - α - θ \\ = 90 - a sin ( sin β / 1.49 ) - 3 \\ = 87 - a sin ( sin β / 1.49 )\end{matrix} \qquad ( 5 )$$

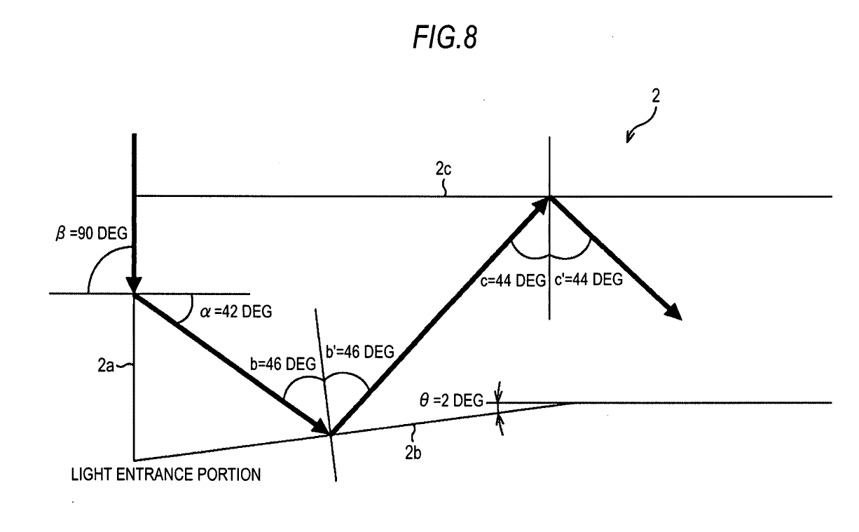

According to the equations (4), respective light incident angles b, c, d . . . the light guide plate 2 when the trumpet angle θ of the light guide plate 2 is changed to 2 deg, 3 deg, 6 deg, 8 deg . . . can be easily calculated. How light from the light source is guided inside the light guide plate 2 in the above cases is shown in FIG. 8 to FIG. 11. Assume that the light incident angle β from the light source to the light guide plate 2 is 90 deg In FIG. 8 to FIG. 11. The fact that the incident angle β is 90 deg means that light from the light source enters into the upper surface 2c of the light guide plate 2 from the vertical direction.

FIG. 8 is a view showing how the light from the light source is guided when the trumpet angle θ of the light guide plate 2 is 2 deg.

In FIG. 8, when light from the light source is incident on the light guide plate 2 at the incident angle β=90 deg, light is guided inside the light guide plate 2 at the refractive angle α=42 deg and propagates inside the light guide plate 2 in the direction of the lower surface 2b.

The incident angle “b” of the light with respect to the lower surface 2b is 46 deg according to the equations (4). In this case, the incident angle “b” is larger than 42 deg which is the critical angle, therefore, light is reflected on the lower surface 2b for the first time at a reflection angle b′=46 deg.

The light reflected on the lower surface 2b at the reflection angle b′=46 deg propagates inside the light guide plate 2 in the direction of the upper surface 2c.

The incident angle “c” of the light with respect to the upper surface 2c will be 44 deg according to the equations (4). In this case, the incident angle “c” is larger than 42 deg which is the critical angle, therefore, light is reflected on the upper surface 2 for the second time at a reflection angle c′=44 deg.

As described above, when the trumpet angle θ of the light guide plate 2 is 2 deg, the first light incident angle “b” and the second light incident angle “c” are both larger than 42 deg which is the critical angle, therefore, the light from the light source is guided inside the light guide plate 2.

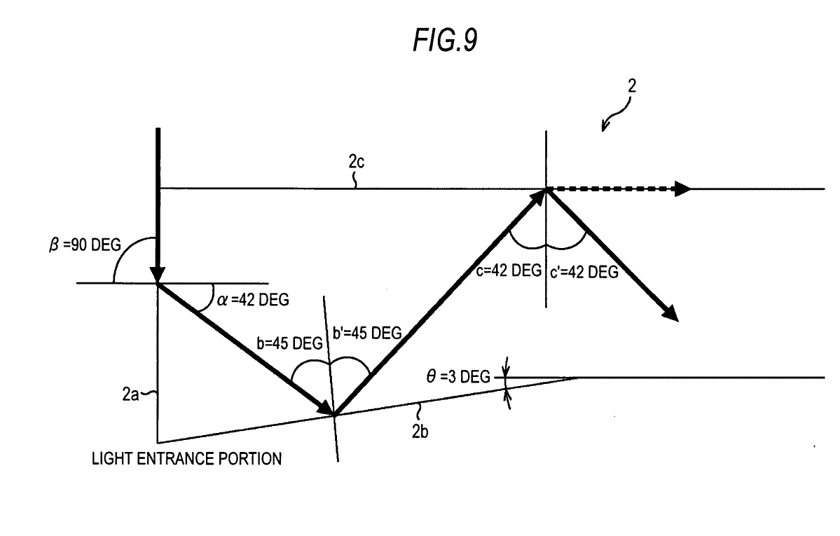

FIG. 9 is a view showing how the light from the light source is guided when the trumpet angle θ of the light guide plate 2 is 3 deg.

In FIG. 9, when light from the light source is incident on the light guide plate 2 at the incident angle β=90 deg, light is guided inside the light guide plate 2 at the refractive angle α=42 deg and propagates inside the light guide plate 2 in the direction of the lower surface 2b.

The incident angle “b” of the light with respect to the lower surface 2b is 45 deg according to the equations (4). In this case, the incident angle “b” is larger than 42 deg which is the critical angle, therefore, light is reflected on the lower surface 2b for the first time at a reflection angle b′=45 deg.

The light reflected on the lower surface 2b at the reflection angle b′=45 deg propagates inside the light guide plate 2 in the direction of the upper surface 2c.

The incident angle “c” of the light with respect to the upper surface 2c will be 42 deg according to the equations (4). In this case, the incident angle “c” is just the same as deg which is the critical angle. Therefore, light is reflected on the upper surface 2c for the second time at a reflection angle c′=42 deg.

As described above, when the trumpet angle θ of the light guide plate 2 is 3 deg, the first light incident angle “b” and the second light incident angle “c” are both equal to or larger than 42 deg which is the critical angle, therefore, the light from the light source is guided inside the light guide plate 2.

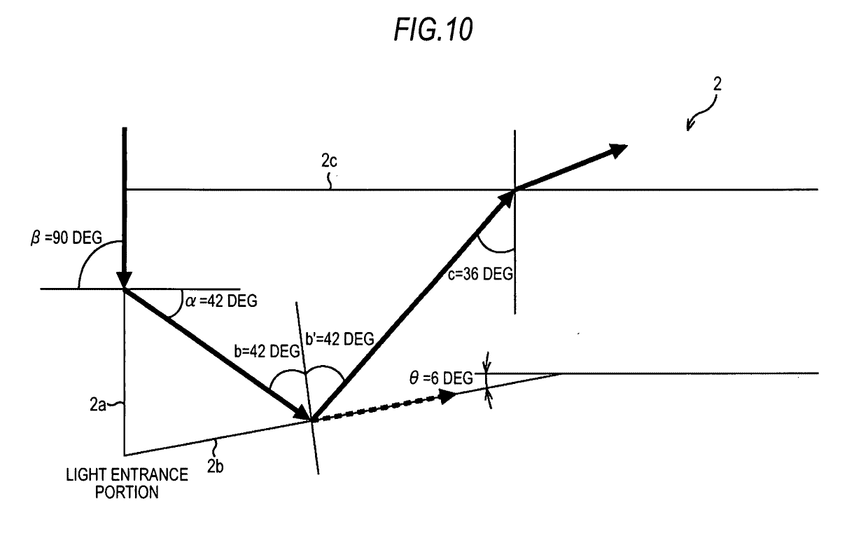

FIG. 10 is a view showing how the light from the light source is guided when the trumpet angle θ of the light guide plate 2 is 6 deg.

In FIG. 10, when light from the light source is incident on the light guide plate 2 at the incident angle β=90 deg, light is guided inside the light guide plate 2 at the refractive angle α=42 deg and propagates inside the light guide plate 2 in the direction of the lower surface 2b.

The incident angle “b” of the light with respect to the upper surface 2b will be 42 deg according to the equations (4). In this case, the incident angle “b” is just the same as deg which is the critical angle. Therefore, light is reflected on the upper surface 2b for the first time at a reflection angle b′=42 deg.

The light reflected on the lower surface 2b at the reflection angle b′=42 deg propagates inside the light guide plate 2 in the direction of the upper surface 2c.

The incident angle “c” of the light with respect to the upper surface 2c will be 36 deg according to the equations (4). In this case, the incident angle “c” is less than 42 deg which is the critical angle, therefore, light incident on the upper surface 2c escapes out of the light guide plate 2.

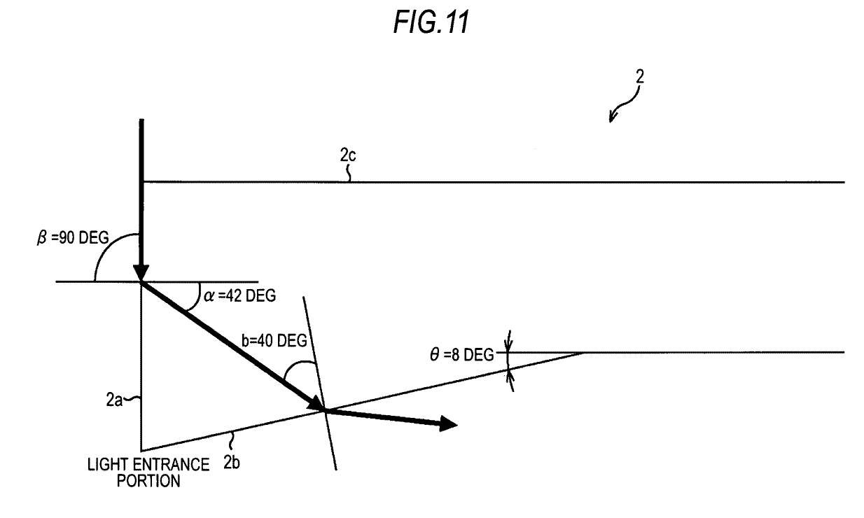

FIG. 11 is a view showing how the light from the light source is guided when the trumpet angle θ of the light guide plate 2 is 8 deg.

In FIG. 11, when light from the light source is incident on the light guide plate 2 at the incident angle β=90 deg, light is guided inside the light guide plate 2 at the refractive angle α=42 deg and propagates inside the light guide plate 2 in the direction of the lower surface 2b.

The incident angle “b” of the light with respect to the upper surface 2c will be 40 deg according to the equations (4). In this case, the incident angle “b” is less than 42 deg which is the critical angle, therefore, light incident on the upper surface 2b escapes out of the light guide plate 2.

As described above, light entering into the light guide plate 2 from the light source propagates in a direction toward one of the lower surface 2b and the upper surface 2c of the light guide plate 2. When the incident angle to one of surfaces is equal to or larger than 42 deg, light is reflected on one surface and propagates in a direction toward the other surface, which will be repeated. However, as long as the lower surface 2b is inclined at the trumpet angle θ, the incident angle becomes smaller in proportion as reflection is repeated. As a result, light is not reflected at a position on the lower surface 2b or the upper surface 2c where the incident angle is smaller than 42 deg which is the critical angle, and escapes out of the light guide plate 2.

On the other hand, the first incident angle “b” with respect to the lower surface 2b is reduced in proportion as the trumpet angle θ becomes larger. Naturally, the incident angles after the second time will be further reduced. Therefore, the number of times that light entering into the light guide plate 2 from the light source repeats the reflection in the light guide plate 2 without escaping out of the light guide plate 2 (referred to as the number of repeated reflections in the following description) is reduced as the trumpet angle θ becomes larger.

For example, in the above example in which the light incident angle with respect to the light guide plate 2 from the light source is 90 deg and the lower surface 2b is inclined at the trumpet angle θ, the number of repeated reflections is two or more when the trumpet angle θ is equal to or smaller than 3 deg. However, when the trumpet angle θ is larger than 3 deg as well as equal or smaller than 6 deg, the number of repeated reflections is just once, that is, light is reflected only once. Moreover, when the trumpet angle θ is larger than 6 deg, for example, when the trumpet angle θ is 8 deg as shown in FIG. 11, the number of repeated reflections is 0 times, namely, no light is reflected at all.

That is to say, when the trumpet angle θ is set to be large, it is possible to make the entire display device thinner and lighter easily, whereas the number of repeated reflections is reduced. However, the length from the light entrance portion to the front edge portion is determined by a screen size of the display device. On the other hand, when light escapes out of the light guide plate 2, the light guiding efficiency of the light guide plate 2 is reduced, therefore, it is necessary to prevent light from escaping out of the light guide plate 2 wherever possible. Therefore, a certain number of repeated reflections has to be secured. This means that it is not always advantageous to simply set the trumpet angle θ to be larger.

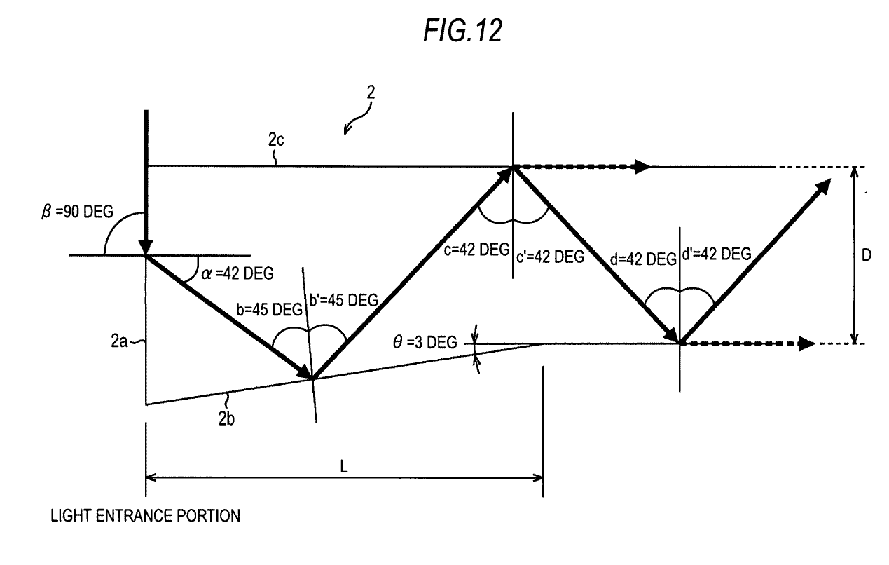

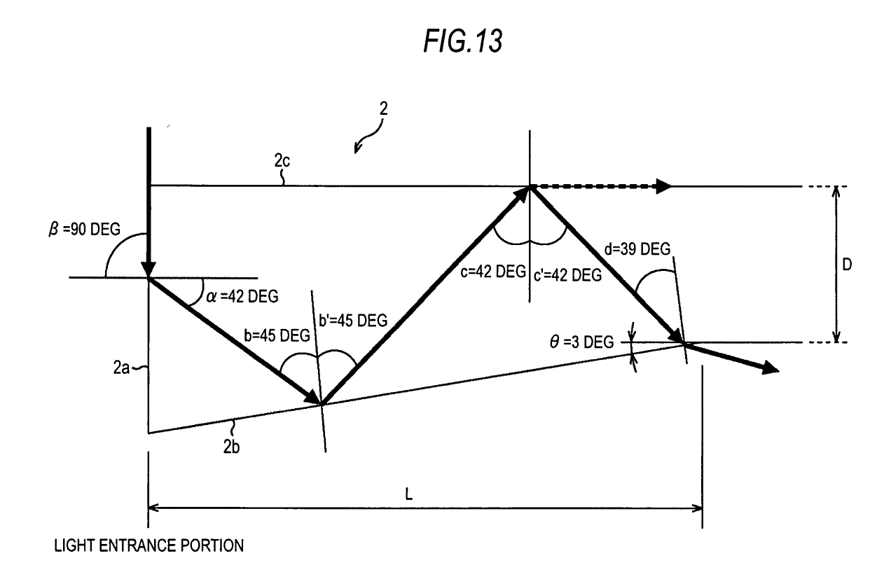

However, the number of repeated reflections is confined because there is the condition that the lower surface 2b is inclined at the trumpet angle θ. When the upper surface 2a is parallel to the lower surface 2b, the number of repeated reflections is not confined. When 0=0 is substituted into the equations (4), incident angles “b” to “f” are all fixed to “90−α”, and light is reflected if “90−α” is equal to or larger than 42 deg. This will be explained with reference to FIG. 12 and FIG. 13.

Here, a portion at which the lower surface 2b is inclined at the trumpet angle θ in the vicinity of the light entrance portion of the light guide plate 2 is referred to as a trumpet portion in the following description. The length of the trumpet portion is represented as “L”.

FIG. 12 and FIG. 13 are views showing the relation between the length “L” of the trumpet portion and the number of repeated reflections.

In FIG. 12 and FIG. 13, assume that the light incident angle β from the light source to the light guide plate 2 is 90 deg. The trumpet angle of the light guide plate 2 is assumed to be 3 deg.

In FIG. 12, the length “L” of the trumpet portion of the light guide plate 2 is set to be longer than the length of a position in the upper surface 2c or the lower surface 2b on which light is incident for the second time as well as shorter than the length of a position in the upper surface 2c or the lower surface 2b on which light is incident for the third time.

In FIG. 12, when light from the light source is incident on the light guide plate 2 at the incident angle=90 deg, light is guided inside the light guide plate 2 at the refractive angle=42 deg and propagates inside the light guide plate 2 in the direction of the lower surface 2b.

The incident angle “b” of the light with respect to the lower surface 2b is 45 deg according to the equations (4). In this case, the incident angle “b” is larger than 42 deg which is the critical angle, therefore, light is reflected on the lower surface 2b for the first time at a reflection angle b′=45 deg.

The light reflected on the lower surface 2b at the reflection angle b′=45 deg propagates inside the light guide plate 2 in the direction of the upper surface 2c.

The incident angle “c” of the light with respect to the upper surface 2c will be 42 deg according to the equations (4). In this case, the incident angle “c” is just the same as deg which is the critical angle. Therefore, light is reflected on the upper surface 2c for the second time at a reflection angle c′=42 deg.

The light reflected on the lower surface 2c at the reflection angle c′=42 deg propagates inside the light guide plate 2 in the direction of the upper surface 2b.

The incident angle “d” of the light with respect to the upper surface 2b will be 42 deg according to the equations (4) into which the trumpet angle β=0 is substituted. In this case, the incident angle “d” is just the same as 42 deg which is the critical angle. Therefore, light is reflected on the lower surface 2b for the third time at a reflection angle d′=42 deg.

After that, the light is guided inside the light guide plate 2 to the front edge portion while repeating reflections on the upper surface 2c or the lower surface 2b at the incident angle=the reflection angle=42 deg according to the equations (4) into which the trumpet angle β=0.

On the other hand, in FIG. 13, the length “L” of the trumpet portion of the light guide plate 2 is set to be longer than the length of a position in the upper surface 2c or the lower surface 2b on which light is incident for the third time.

In FIG. 13, when light from the light source is incident on the light guide plate 2 at the incident angle β=90 deg, light is guided inside the light guide plate 2 at the refractive angle α=42 deg and propagates inside the light guide plate 2 in the direction of the lower surface 2b.

The incident angle “b” of the light with respect to the lower surface 2b is 45 deg according to the equations (4). In this case, the incident angle “b” is larger than 42 deg which is the critical angle, therefore, light is reflected on the lower surface 2b for the first time at a reflection angle b′=45 deg.

The light reflected on the lower surface 2b at the reflection angle b′=45 deg propagates inside the light guide plate 2 in the direction of the upper surface 2c.

The incident angle “c” of the light with respect to the upper surface 2c will be 42 deg according to the equations (4). In this case, the incident angle “c” is just the same as deg which is the critical angle. Therefore, light is reflected on the upper surface 2c for the second time at a reflection angle c′=42 deg.

The light reflected on the lower surface 2c at the reflection angle c′=42 deg propagates inside the light guide plate 2 in the direction of the upper surface 2b.

The incident angle “d” of the light with respect to the upper surface 2c will be 39 deg according to the equations (4). In this case, the incident angle “b” is less than 42 deg which is the critical angle, therefore, light incident on the upper surface 2b escapes out of the light guide plate 2.

As can be seen from FIG. 12 and FIG. 13, when the trumpet angle θ of the light guide plate 2 is just the same, the longer the length “L” of the trumpet portion of the light guide plate 2 is, the thinner a thickness “D” of the front edge portion of the light guide plate 2 becomes. As the thickness “D” of the front edge portion is thinner and thinner, it is possible to contribute to realization of a thinner and lighter liquid crystal display device. However, as shown in FIG. 13, when the length “L” of the trumpet potion of the light guide plate 2 is made longer to more than the fixed length, light escapes outside without being reflected inside the light guide plate 2, which reduces the light guiding efficiency of the light guide plate 2. Therefore, it is necessary to determine the length “L” of the trumpet portion to be within a range in which the light incident angle with respect to the upper surface 2c or the lower surface 2b becomes equal to or smaller than 42 deg. That is, the length “L” of the trumpet portion depends on the number of repeated reflections inside the trumpet portions.

The number of repeated reflections inside the trumpet portion is determined by the trumpet angle θ and the first light incident angle on the upper surface 2c or the lower surface 2b. The latter condition, namely, the first light incident angle on the upper surface 2c or the lower surface 2b is determined by the refracting angle α of light which is incident on the light guide plate 2 from the light source, namely, the incident angle β at which light from the light source is incident on the light guide plate 2.

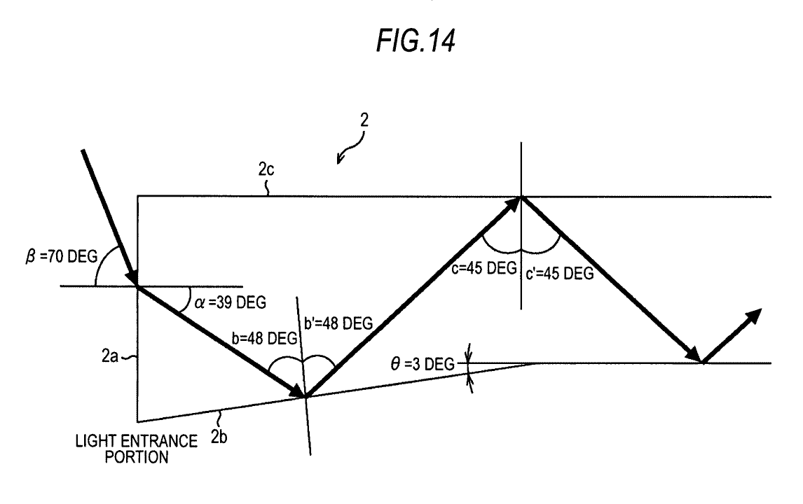

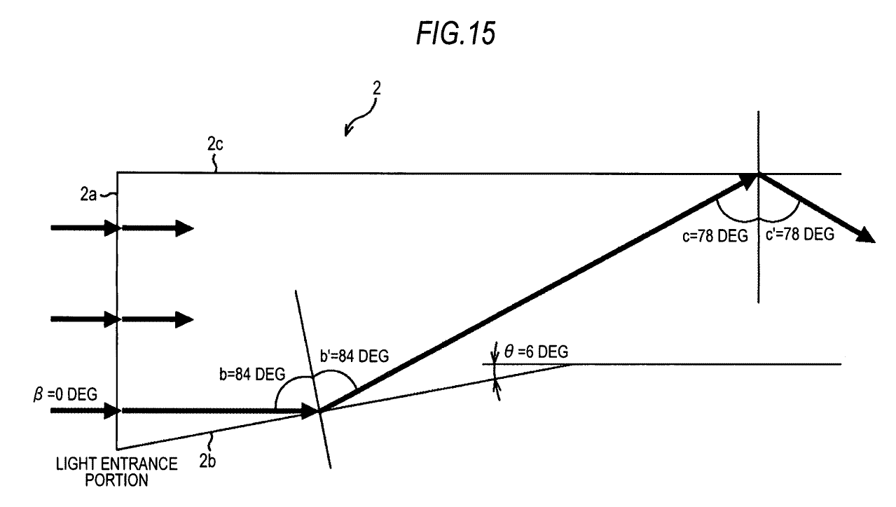

Accordingly, how light is guided inside the light guide plate 2 according to the difference of the incident angle β will be explained with reference to FIG. 14 and FIG. 15 below.

FIG. 14 is a view showing how the light from the light source is guided in the case that the light incident angle β from the light source to the light guide plate 2 is 70 deg and the trumpet angle θ of the light guide plate 2 is 3 deg.

In FIG. 14, when light from the light source is incident on the light guide plate 2 at the incident angle β=70 deg, the light is guided inside the light guide plate 2 at the refractive angle α=39 deg and propagates inside the light guide plate 2 in the direction of the lower surface 2b.

The incident angle “b” of the light with respect to the lower surface 2b is 48 deg according to the equations (4). In this case, the incident angle “b” is larger than 42 deg which is the critical angle, therefore, light is reflected on the lower surface 2b for the first time at a reflection angle b′=48 deg.

The light reflected on the lower surface 2b with the reflection angle b′=48 deg propagates inside the light guide plate 2 in the direction of the upper surface 2c.

The incident angle “c” of the light with respect to the upper surface 2c will be 45 deg according to the equations (4). In this case, the incident angle “c” is larger than 42 deg which is the critical angle. Therefore, light is reflected on the upper surface 2c for the second time at a reflection angle c′=45 deg.

On the other hand, in the example of FIG. 9, that is, in the example in which the light incident angle β from the light source to the light guide plate 2 was 90 deg, the second light incident angle “c” was the same as 42 deg which is the critical angle. In short, when the trumpet angle θ is the same at 3 deg, the smaller the light incident angle β from the light source to the light guide plate 2 becomes, the larger the incident angle of light on the upper surface 2c or the lower surface 2b inside the light guide plate 2 becomes.

FIG. 15 is a view showing how light from the light source is guided in the case that the light incident angle β from the light source to the light guide plate 2 is 0 deg and the trumpet angle θ of the light guide plate 2 is 6 deg.

The incident angle β=0 deg means that light from the light source enters to the upper surface 2c of the light guide plate 2 from the horizontal direction. That is, when the light from the light source is incident on the light guide plate 2 at the incident angle β=0 deg, the light propagates in parallel to the upper surface 2c and reaches the lower surface 2b.

At this time, the incident angle “b” of the light with respect to the lower surface 2b is 84 deg according to the equations (4). In this case, the incident angle “b” is larger than 42 deg which is the critical angle, therefore, light is reflected on the lower surface 2b for the first time at a reflection angle b′=84 deg.

The light reflected on the lower surface 2b with the reflection angle b′=84 deg propagates inside the light guide plate 2 in the direction of the upper surface 2c.

The incident angle “c” of the light with respect to the upper surface 2c will be 78 deg according to the equations (4). In this case, the incident angle “c” is larger than 42 deg which is the critical angle. Therefore, light is reflected on the upper surface 2c for the second time at a reflection angle c′=78 deg.

On the other hand, in the example of FIG. 14, namely, the example in which the light incident angle β from the light source to the light guide plate 2 was 70 deg, the second light incident angle “c” was 45 deg. That is, when the light incident angle β from the light source to the light guide plate 2 is made small to 0 deg, the incident angle of light in the light guide plate 2 with respect to the upper surface 2c or the lower surface 2b becomes drastically large even when the trumpet angle θ is set to 6 deg which is larger than 3 deg in the example of FIG. 14.

As described above, the smaller the light incident angle β from the light source to the light guide plate 2 becomes, the larger the incident angle of light on the upper surface 2c or the lower surface 2b inside the light guide plate 2 becomes. Therefore, it can be seen that the trumpet angle θ can be taken larger when the incident angle β from the light source to the light guide plate 2 is made smaller. In the case that the trumpet angle θ is the same, the length “L” of the trumpet portion can be made longer in proportion as the light incident angle β from the light source to the light guide plate 2 becomes smaller.

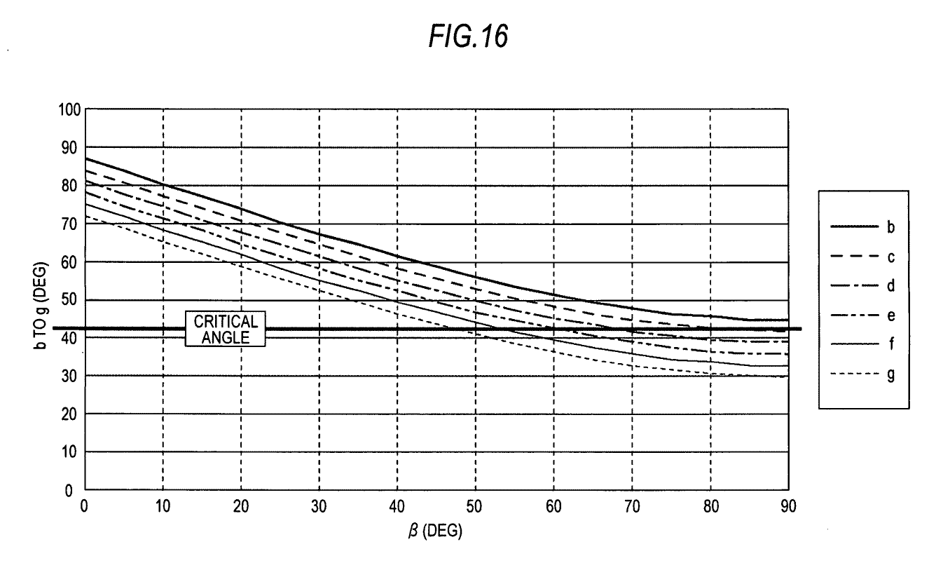

The contents of the above description will be sorted out with reference to graphs of FIG. 16 to FIG. 19.

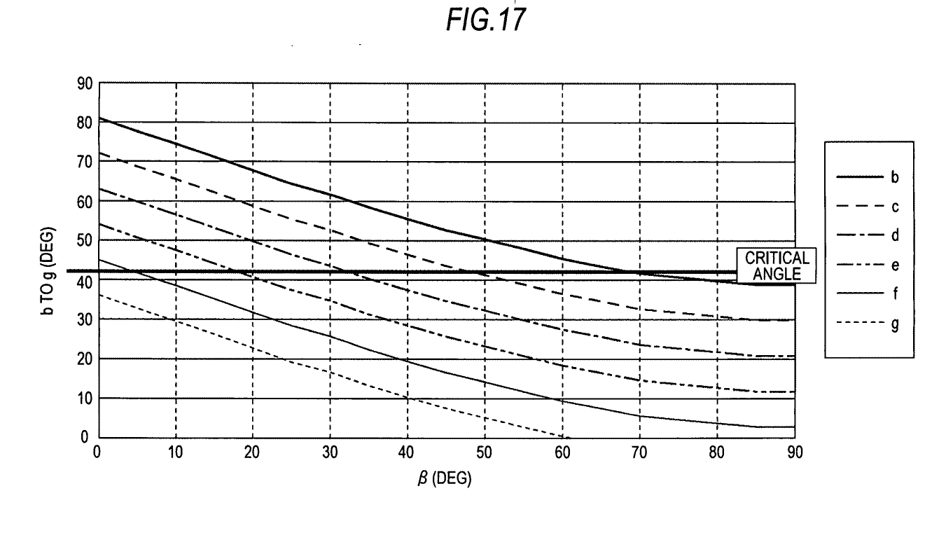

FIG. 16 and FIG. 17 are graphs respectively showing the relation between the light incident angle β from the light source and incident angles “b” to “g” of the upper surface 2c or the lower surface 2b inside the light guide plate 2 in the case that the trumpet angle θ of the light guide plate 2 is 3 deg and in the case that the angle is 9 deg.

In FIG. 16 and FIG. 17, the vertical axis represents the incident angles “b” to “g” and the horizontal axis represents the light incident angle β from the light source.

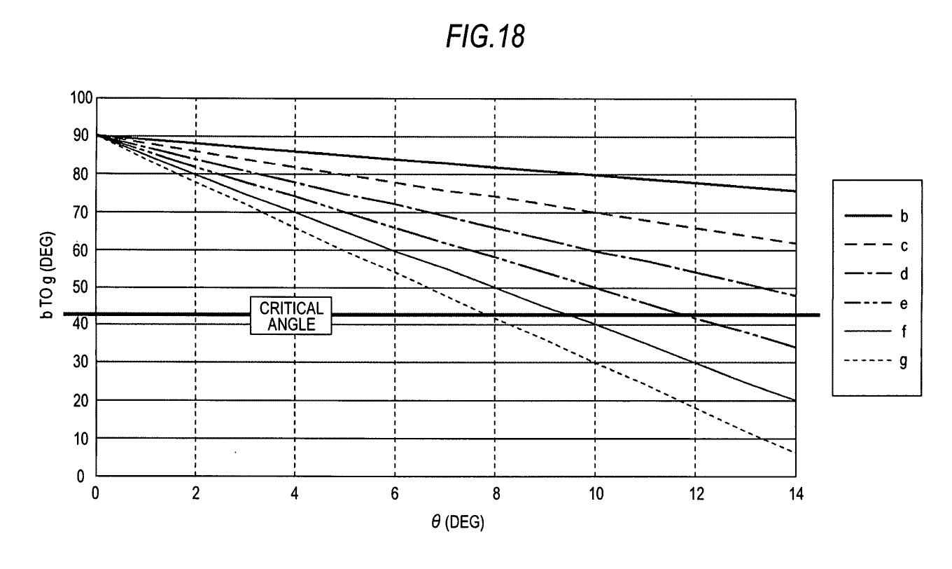

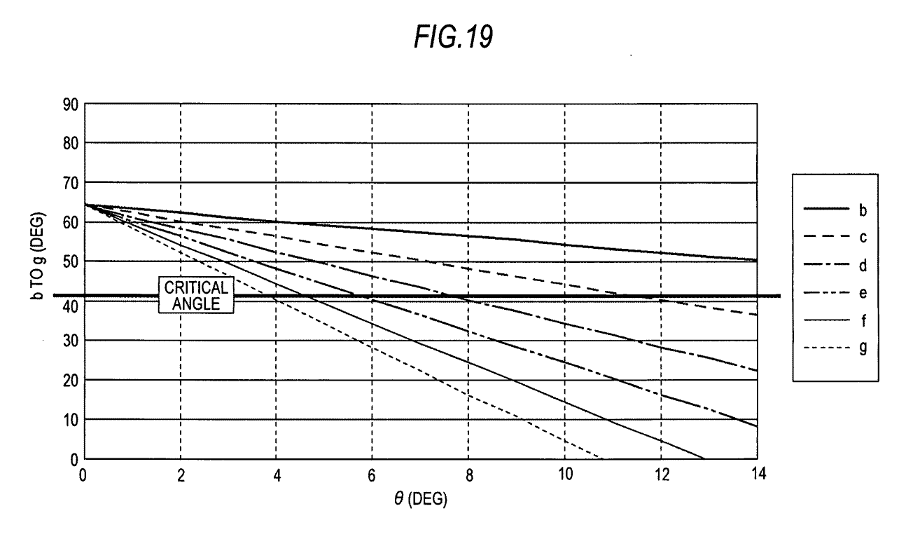

The incident angles “b” to “g” show respective incident angles on the first to the sixth time with respect to the upper surface 2c and the lower surface 2b inside the light guide plate 2. Accordingly, the incident angles “b” to “g” are referred to as first to sixth light incident angles. The first light incident angle “b” is shown by a solid line (heavy line) curve. The second light incident angle “c” is shown by a dotted line (heavy line) curve. The third light incident angle “d” is shown by a dashed line curve. The fourth light incident angle “e” is shown by a double-dashed line curve. The fifth light incident angle “f” is shown by a solid (thin line) curve. The sixth light incident angle “g” is shown by a dotted line (thin line) curve. The contents of the paragraph are applicable not only to FIG. 16 and FIG. 17 but also to FIG. 18 and FIG. 19.

For example, when the trumpet angle θ is 3 deg and the light incident angle β is 10 deg, the first light incident angle “b” is approximately 80 deg, the second light incident angle “c” is approximately 77 deg and the third light incident angle “d” is approximately 75 deg as shown in FIG. 16. The forth light incident angle “e” is approximately 71 deg, the fifth light incident angle “f” is approximately 68 deg and the sixth light incident angle “g” is approximately 65 deg. As just described, all light incident angles “b” to “g” on the first to the sixth time are larger than 42 deg which is the critical angle. Therefore, light entering from the light source repeats reflections on the upper surface 2c or the lower surface 2b at least six times to be guided inside the light guide plate 2.

On the other hand, for example, in the case that incident angle β of light from the light source is 70 deg, the first light incident angle “b” is approximately 48 deg, the second light incident angle “c” is approximately 45 deg and the third light incident angle “d” is approximately 41 deg even when the trumpet angle θ is the same at, for example, 3 deg. The fourth light incident angle “e” is approximately 39 deg, the fifth light incident angle “f” is approximately 36 deg and the sixth light incident angle “g” is approximately 32 deg. As just described, the first light incident angle “b” and the second light incident angle “c” are larger than 42 deg which is the critical angle. Therefore, the light entering from the light source is reflected on the lower surface 2b for the first time and is reflected on the upper surface 2c for the second time. However, the third light incident angle “c” is smaller than 42 deg, therefore, light is not reflected on the lower surface 2b for the third time, as a result, the light escapes out of the light guide plate 2.

As described above, when the trumpet angle θ is the same, the number of repeated reflections in the trumpet portion can be increased by reducing the light incident angle β from the light source, as a result, the length “L” of the trumpet portion can be made longer.

For example, when the light incident angle β from the light source is 10 deg and the trumpet angle θ of 9 deg, the first light incident angle “b” is approximately 75 deg, the second light incident angle “c” is approximately 67 deg and the third light incident angle “d” is approximately 58 deg as shown in FIG. 17. The fourth light incident angle “e” is approximately 48 deg, the fifth light incident angle “f” is approximately 39 deg and the sixth light incident angle “g” is approximately 30 deg. As just described, the first to the fourth light incident angles “b” to “e” are larger than 42 deg which is the critical angle. Therefore, the light entering from the light source is reflected on the lower surface 2b for the first time, reflected on the upper surface 2c for the second time, reflected on the lower surface 2b for the third time and reflected on the upper surface 2c for the fourth time. However, the fifth light incident angle “f” is smaller than 42 deg which is the critical angle, therefore, the light is not reflected on the lower surface 2b for the fifth time, and the light escapes out of the light guide plate 2.

Moreover, for example, when the light incident angle β from the light source is 70 deg and the trumpet angle θ is 9 deg, the first light incident angle “b” is approximately 41 deg, the second light incident angle “c” is approximately 32 deg and the third light incident angle “d” is approximately 23 deg as shown in FIG. 17. The fourth light incident angle “e” is approximately 15 deg and the fifth light incident angle “f” is approximately 5 deg. As just described, even the first light incident angle “b” is smaller than 42 deg as the critical angle, therefore, the light is not reflected even once and escapes out of the light guide plate 2.

As described above, when the trumpet angle θ is large, the number of repeated reflections in the trumpet portion is reduced even when the light incident angle β from the light source is the same, as a result, the length “L” of the trumpet portion is reduced. This will be further explained with reference to FIG. 18 and FIG. 19.

FIG. 18 is a graph showing the relation between the trumpet angle θ and the first to the sixth light incident angles “b” to “g” inside the light guide plate 2 when the light incident angle β from the light source is 0 deg.

In FIG. 18, the vertical axis represents light incident angles “b” to “g” inside the light guide plate 2 and the horizontal axis represents the trumpet angle θ of the light guide plate 2.

For example, when the light incident angle β from the light source is 0 deg and the trumpet angle θ is 3 deg, the first light incident angle “b” is approximately 87 deg, the second light incident angle “c” is approximately 84 deg and the third light incident angle “d” is approximately 81 deg as shown in FIG. 18. The fourth light incident angle “e” is approximately 78 deg, the fifth light incident angle “f” is approximately 75 deg and the sixth light incident angle “g” is approximately 72 deg. As just described, all the first to the sixth light incident angles are larger than 42 deg which is the critical angle. Therefore, the light entering from the light source repeats reflections on the upper surface 2c or the lower surface 2b at least six times to be guided inside the light guide plate 2.

On the other hand, for example, when the trumpet angle θ is increased to 9 deg under the condition that the light incident angle β from the light source is the same as 0 deg, the first light incident angle “b” is approximately 81 deg, the second light incident angle “c” is approximately 72 deg and the third light incident angle “d” is approximately 62 deg as shown in FIG. 18. The fourth light incident angle “e” is approximately 55 deg, the fifth light incident angle “f” is approximately 45 deg and the sixth light incident angle “g” is approximately 36 deg. As just described, the first to the fifth light incident angles “b” to “f” are larger than 42 deg which is the critical angle. Therefore, the light entering from the light source is reflected on the lower surface 2b for the first time, reflected on the upper surface 2c for the second time, reflected on the lower surface 2b for the third time, reflected on the upper surface 2c for the fourth time and reflected on the lower surface 2b for the fifth time. However, the sixth light incident angle is smaller than 42 deg as the critical angle, therefore, the sixth light reflection on the upper surface 2c does not occur, and the light escapes out of the light guide plate 2 at that point.

FIG. 19 is a graph showing the relation between the trumpet angle θ and the first to the sixth light incident angles “b” to “g” inside the light guide plate 2 when the light incident angle β from the light source is 40 deg.

In FIG. 19, the vertical axis represents light incident angles “b” to “g” inside the light guide plate 2 and the horizontal axis represents the trumpet angle θ of the light guide plate 2.

For example, when the light incident angle β from the light source is 40 deg and the trumpet angle θ is 3 deg, the first light incident angle “b” is approximately 61 deg, the second light incident angle “c” is approximately 59 deg and the third light incident angle “d” is approximately 57 deg as shown in FIG. 19. The fourth light incident angle “e” is approximately 52 deg, the fifth light incident angle “f” is approximately 50 deg and the sixth light incident angle “g” is approximately 46 deg. As just described, all the first to the sixth light incident angles are larger than 42 deg which is the critical angle. Therefore, the light entering from the light source repeats reflections on the upper surface 2c or the lower surface 2b at least six times to be guided inside the light guide plate 2.

On the other hand, for example, when the trumpet angle θ is increased to 9 deg under the condition that the light incident angle from the light source is the same at 40 deg, the first light incident angle “b” is approximately 57 deg, the second light incident angle “c” is approximately 47 deg and the third light incident angle “d” is approximately 38 deg as shown in FIG. 19. The fourth light incident angle “e” is approximately 28 deg, the fifth light incident angle “f” is approximately 20 deg and the sixth light incident angle “g” is approximately 10 deg. As just described, the first and the second light incident angles “b” and “c” are larger than 42 deg which is the critical angle. Therefore, the light entering from the light source is reflected on the lower surface 2b for the first time and reflected on the upper surface 2c for the second time. However, the third light incident angle is smaller than 42 deg as the critical angle, therefore, the third light reflection on the upper surface 2c does not occur, and the light escapes out of the light guide plate 2 at that point.

As described above, when the trumpet angle θ is large, the number of repeated reflections in the trumpet portion is reduced even when the light incident angle β from the light source is the same, as a result, the length “L” of the trumpet portion is reduced.

A method of forming graphs of FIG. 16 to FIG. 19 described above is as follows.

That is, all graphs of FIG. 16 to FIG. 19 are formed based on the above equations (4).

Specifically, the graph shown in FIG. 16 is formed in a manner that the right side of the above equation (3) is substituted into the refractive angle α in each right side of each equations (4) respectively, and 3 deg is substituted into the trumpet angle θ in each right side of each equations (4), further, the light incident angles β from the light source are taken as variables (x-axis) to form the graph.

Similarly, the graph shown in FIG. 17 is formed in a manner that the right side of the above equation (3) is substituted into the refractive angle α in each right side of each equations (4) respectively, and 9 deg is substituted into the trumpet angle θ in each right side of each equations (4), further, the light incident angles β from the light source are taken as variables (x-axis) to form the graph.

Moreover, the graph shown in FIG. 18 is formed in a manner that the right side of the above equation (3) is substituted into the refractive angle α in each right side of each equations (4) respectively, and “0 (zero)” is substituted into the light incident angle β from the light source, further, the trumpet angles β are taken as variables (x-axis) to form the graph.

That is, when the light incident angle β from the light source to the light guide plate 2 is “0 (zero)” deg, the first light incident angle “b” can be represented as the following equation (6) based on the equations (3), (4).

$$\begin{matrix}b = 90 - α - θ \\ = 90 - a sin ( sin β / 1.49 ) - θ \\ = 90 - a sin ( sin 0 / 1.49 ) - θ \\ = 90 - θ\end{matrix} \qquad ( 6 )$$

Similarly, the second light incident angle “c” can be represented as the following equation (7).

c=90−α−2θ

C=90−2θ (7)

The curves representing the above equations (6), (7) respectively will be the solid line (heavy line) curve representing the first light incident angle “b” and the dotted line (heavy line) curve representing the second light incident angle “c” respectively in the graph of FIG. 18.

The dashed line curve representing the third light incident angle “d” to the dotted line (thin line) curve representing the sixth light incident angle “g” in FIG. 18 can be also mathematically expressed in the same manner as the above, though respective equations are omitted.

When the light incident angle β from the light source to the light guide plate 2 is 40 deg, a will be 25.6 according to the equation (3). Therefore, the first light incident angle “b” can be represented as the following equation (8).

$$\begin{matrix}b = 90 - α - θ \\ = 90 - 25.6 - θ \\ = 64.4 - θ\end{matrix} \qquad ( 8 )$$

The curve representing the equation (8) will be the solid line (heavy line) curve representing the first light incident angle “b” in the graph of FIG. 19.

The dotted line (heave line) curve representing the second light incident angle “c” to the dotted line (thin line) curve representing the sixth light incident angle “g” in FIG. 19 can be also mathematically expressed in the same manner as the above, though respective equations are omitted.

As has been explained above, it is effective to reduce the thickness of the front edge portion “D” of the light guide plate 2 in order to allow the liquid crystal display device to thinner and lighter. In order to reduce the thickness of the front edge portion “D” of the light guide plate 2, it is effective to set the trumpet angle θ to be larger and the length “L” of the trumpet portion to be longer.

However, when the trumpet angle θ is set to be large and the length “L” of the trumpet portion is set to be long blindly, light escapes out of the light guide plate 2 without reflection in the trumpet portion, which reduces the light guiding efficiency of the light guide plate 2.

Accordingly, it is necessary to set the trumpet angle θ and the length “L” of the trumpet portion so as to satisfy the condition that all light incident angles in the trumpet portion are equal to or larger than 42 deg which is the critical angle to prevent light guiding efficiency of the light guide plate 2 from being reduced.

In this case, it is possible to visually recognize whether light incident angles in the trumpet portion, namely, the first light incident angle “b” to the sixth light incident angle “g” are equal to or larger than 42 deg as the critical angle or not by using the graphs of FIG. 16 to FIG. 19. That is, it is possible to set the trumpet angle θ and the length “L” of the trumpet portion easily.

Specifically, for example, the number of curves existing on a straight line representing 42 deg as the critical angle or existing above the straight line indicates the number of times that the light is reflected on the upper surface 2c or the lower surface 2b inside the light guide plate 2, namely, the number of repeated reflections. As the number of repeated reflections is increased, the length “L” of the trumpet portion can be set longer in proportion to the number. Conversely, when the length “L” of the trumpet portion is previously set, the maximum number of repeated reflections can be determined. It is effective to set the trumpet angle θ and the light incident angles β from the light source so that the same number of curves as the maximum number exists on the straight line representing 42 deg as the critical angle or above the straight line.

As apparent from FIG. 16 and FIG. 17, as the light incident angle β from the light source is set to be smaller, the number of repeated reflections in the trumpet portion is increased in proportion to the reduction of the angle. That is, it is possible to increase the trumpet angle θ and increase the length “L” of the trumpet portion when the light incident angle θ from the light source is set to be smaller. As a result, it becomes possible to allow the thickness of the front edge portion “D” of the light guide plate 2 to be thinner easily as well as realize the thinner and lighter liquid crystal display device.

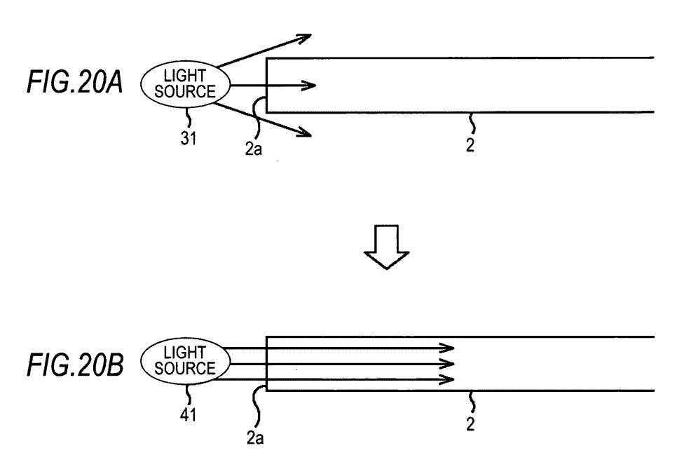

However, as the light source in related art, alight source 31 in which directivity of light is wide such as the lamp 6 of FIG. 1 or the LED 14 of FIG. 2 is applied as shown in FIG. 20A.

FIG. 20A and FIG. 20B are views showing examples of directivity of light from the light source.

As shown in FIG. 20A, light from the light source 31 of related art has wide directivity, therefore, light fluxes having various angles as the light incident angles β are incident on the light entrance surface 2a. In other words, the light source 31 of related art having wide directivity was the light source in which the proportion of light fluxes having incident angles β close to 90 deg is high. Therefore, it is difficult to increase the trumpet angle θ or increase the length “L” of the trumpet portion. Accordingly, it is difficult to reduce the average thickness of the entire light guide plate 2, as a result, it is difficult to allow the liquid crystal display device to thinner and lighter.

Accordingly, the present inventors propose a light source 41 including a light-emitting member and a directivity member which narrows light directivity from the light-emitting member as shown in FIG. 20B.

As can be seen easily when comparing FIG. 20A with FIG. 20B, the light source 41 to which the invention is applied (referred to as the light source 41 of the embodiment of the invention in the following description) has narrow directivity as compared with the light source 31 of related art. Therefore, it is possible to narrow the incident angles β of light fluxes to be incident on the light entrance surface 2a to the vicinity of 0 deg. That is, the light source 41 of the embodiment of the invention is the light source in which the proportion of light fluxes having incident angles β close to 90 deg is low and the proportion of light fluxes having incident angles β close to 0 deg (parallel light fluxes) is high as compared with the light source 31 of related art. Therefore, the light source 41 of the embodiment of the invention is applied to the backlight, thereby increasing the number of repeated reflections in the trumpet portion as compared with related art as apparent from the above FIG. 16 and FIG. 17. As a result, it is possible to increase the trumpet angle θ and the increase the length “L” of the trumpet portion easily. Accordingly, it is possible to reduce the thickness of the front edge portion D of the light guide plate 2 as well as realize the thinner and lighter liquid crystal display with ease.

3. Configuration Examples of the Backlight on which the Light Source Applying the Invention is Mounted

Hereinafter, specific examples of the light source 41 to which the invention is applied (referred to as the light source 41 of the embodiment of the invention in the following description) will be explained.

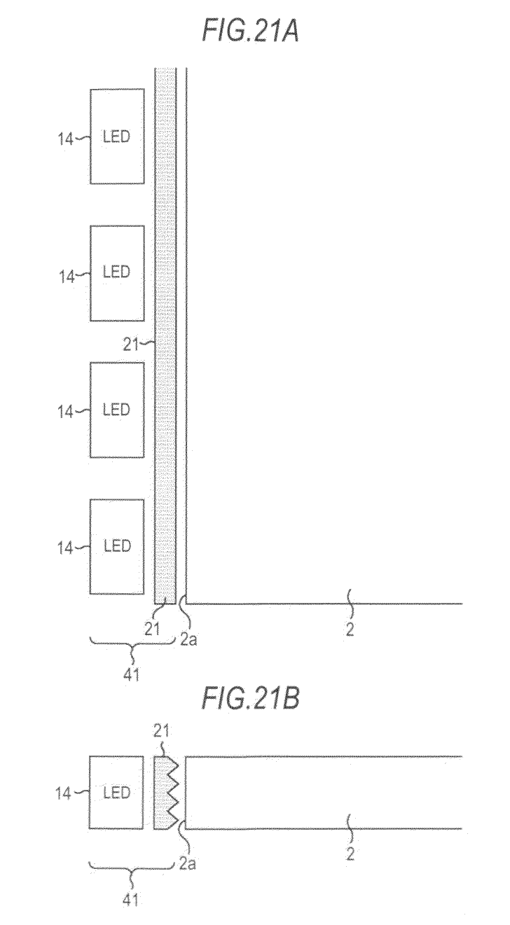

FIG. 21A and FIG. 21B are views showing configuration examples of a portion including the light source of the embodiment of the invention and the light guide plate 2 in the backlight having the configuration of FIG. 2.

FIG. 21A is an upper surface view of a portion including the light source 41 of the embodiment of the invention and the light guide plate 2.

FIG. 21B is a cross-sectional view of a side surface of the portion including the light source 41 of the embodiment of the invention and the light guide plate 2.

The light source 41 of the embodiment of the invention includes LEDs 14 as the light-emitting member and a lens sheet 21 as the directivity member. That is, the lens sheet 21 is arranged between the plural LEDs 14 and a light entrance surface 2a as shown in FIG. 21A.

The lens sheet 21 has a shape whereby the directivity of light entering from the LEDs 14 to the light guide plate 2 can be narrowed. Accordingly, the lens sheet 21 is arranged between the LEDs 14 and the light guide plate 2, thereby narrowing the light incident angles β entering from the LEDs 14 to the light guide plate 2 to smaller angles. In other words, in light entering from the light source 41 to the light guide plate 2, the proportion of light fluxes having incident angles β close to 0 deg (parallel light with respect to the light guide plate 2) is high and the proportion of light fluxes having incident angles β close to 90 deg is low. As a result, the light guiding efficiency rises.

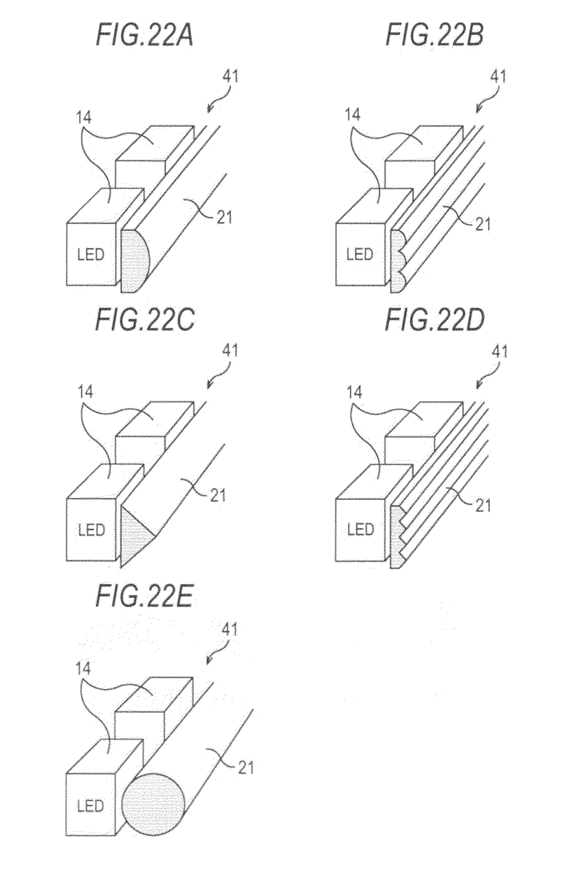

In other words, it is sufficient that the lens sheet 21 has a shape whereby the directivity of light entering from the LEDs 14 to the light guide plate 2 can be narrowed, and the shape is not particularly limited. For example, the lens sheet 21 may have various shapes as shown in FIG. 22A to FIG. 24D.

FIG. 22A to FIG. 22E are perspective views showing various examples of the light source 41 configured to have one lens sheet 21 arranged with respect to plural LEDs 14.

FIG. 22A shows the light source 41 configured to have one lens sheet 21 whose section is a convex lens shape, which is arranged in front of plural LEDs 14.

FIG. 22B shows the light source 41 configured to have one lens sheet 21 whose section is a shape formed by plural-convex lenses, which is arranged in front of plural LEDs 14.

FIG. 22C shows the light source 41 configured to have one lens sheet 21 whose section is a triangle shape, which is arranged in front of plural LEDs 14.

FIG. 22D shows the light source 41 configured to have one lens sheet 21 whose section is a prism lens shape, which is arranged in front of plural LEDs 14.

FIG. 22E shows the light source 41 configured to have one lens sheet 21 having whose section is a circular shape, which is arranged in front of plural LEDs 14.

The shapes of FIG. 22B and FIG. 22D can reduce the thickness of the lens sheet 21 as compared with the shapes of FIG. 22A, FIG. 22C and FIG. 22E.

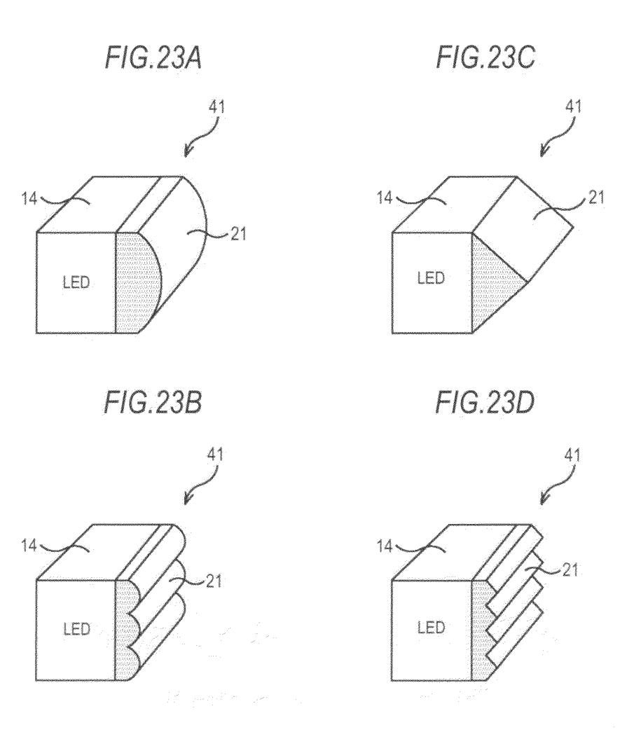

FIG. 23A to FIG. 23D are perspective views showing various examples of the light source 41 configured to have one lens sheet 21 arranged with respect to one LED 14.

In each of examples of FIG. 23A to FIG. 23D, only one LED 14 is shown, however, plural pairs of LED 14 and the lens sheet 21 are actually prepared, and these plural pairs are arranged closed to the light entrance surface 2a of the light guide plate 2. In the following description, each pair of the LED 14 and the lens sheet 21 respectively shown in FIG. 23A to FIG. 23D is referred to as a unit light source. That is, in the examples of FIG. 23A to FIG. 23D, plural unit light sources having any of shapes of FIG. 23A to FIG. 23D constitute the light source 41 of the embodiment of the invention.

FIG. 23A shows a unit light source configured to have one lens sheet 21 whose section is a convex lens shape, which is arranged in front of one LED 14.

FIG. 23B shows a unit light source configured to have one lens sheet 21 whose section is a shape formed by plural-convex lenses, which is arranged in front of one LED 14.

FIG. 23C shows a unit light source configured to have one lens sheet 21 whose section is a triangle shape, which is arranged in front of one LED 14.

FIG. 23D shows a unit light source configured to have one lens sheet 21 whose section is a prism lens shape, which is arranged in front of one LED 14.

The shapes of FIG. 23B and FIG. 23D can reduce the thickness of the lens sheet 21 as compared with the shapes of FIG. 23A and FIG. 23C.

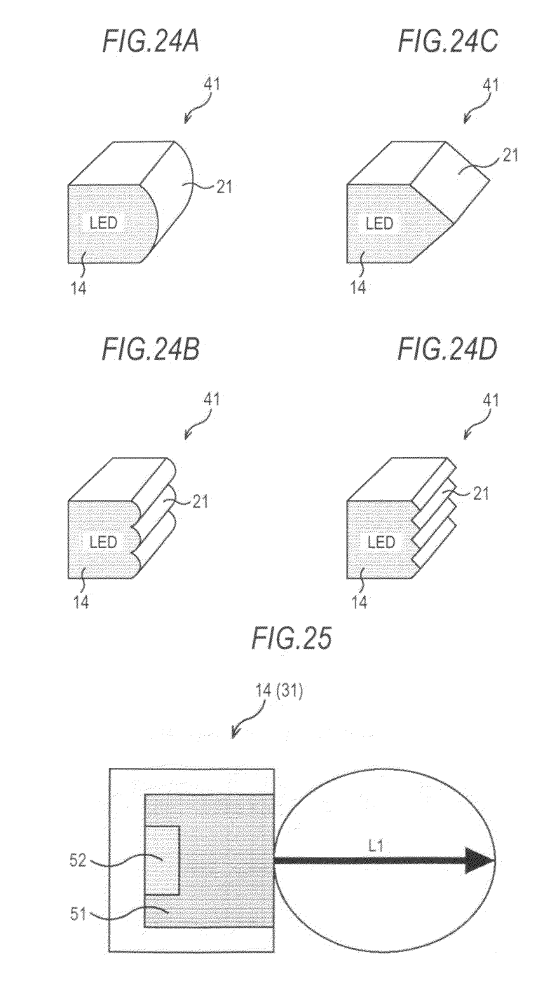

FIG. 24A to FIG. 24D are perspective view showing various examples of the light source 41 obtained by integrating the LED 14 with the lens sheet 21 by applying the lens sheet 21 to resin forming one LED 14.

In each of examples of FIG. 24A to FIG. 24D, only one LED 14 is shown, however, plural pairs of LED 14 and the lens sheet 21 (which are integrated) are actually prepared, and these plural pairs are arranged closed to the light entrance surface 2a of the light guide plate 2. In the following description, each pair of the LED 14 and the lens sheet 21 (which are integrated) respectively shown in FIG. 24A to FIG. 24D is referred to as a unit light source. That is, in the examples of FIG. 24A to FIG. 24D, the aggregation of plural unit light sources having any of shapes of FIG. 24A to FIG. 24D constitute the light source 41 of the embodiment of the invention.

FIG. 24A shows an integrated unit light source formed by applying the lens sheet 21 whose section is a convex lens shape to resin of one LED 14.

FIG. 24B shows an integrated unit light source formed by applying the lens sheet 21 whose section is a shape formed by plural-convex lenses to resin of one LED 14.

FIG. 24C shows an integrated unit light source formed by applying the lens sheet 21 whose section is a triangle shape to resin of one LED 14.

FIG. 24D shows an integrated unit light source formed by applying the lens sheet 21 whose section is a prism lens shape to resin of one LED 14.

The shapes of FIG. 24B and FIG. 24D can reduce the thickness of the integrated unit light source as compared with the shapes of FIG. 24A and FIG. 24C.

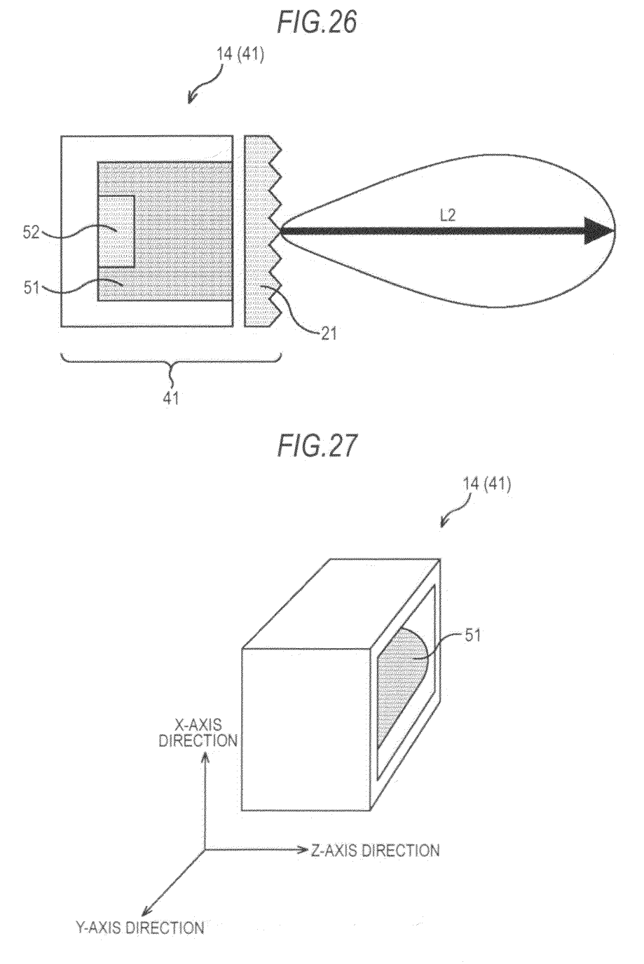

Hereinafter, operations of the light source 41 of the embodiment of the invention including the lens sheet 21 and the LED 14 having the above various shapes will be explained with reference to FIG. 25 and FIG. 26 in comparison with the light source 31 of related art.

FIG. 25 is a view showing the directivity of light of the LED 14 as the light source 31 of related art.

As shown in FIG. 25, the LED 14 as the light source of related art includes a sealant 51 and an LED semiconductor chip 52.

In FIG. 25, an ellipse in front of the light source 31 of related art indicates the directivity of light from the light source 31 of related art. Here, front brightness of the light source 31 of related art is written as “L1” so as to correspond to FIG. 25.

FIG. 26 is a view showing the directivity of light of the light source 41 of the embodiment of the invention, which is formed by arranging the lens sheet 21 in front of the LED 14.

In the example of FIG. 26, the light source 41 of the embodiment of the invention includes the LED 14 having the sealant 51 and the LED semiconductor chip 52 as well as the lens sheet 21.

In FIG. 26, a tear-drop shape in front of the light source 41 of the embodiment of the invention indicates the directivity of light from the light source 41 of the embodiment of the invention. Here, front brightness of the light source 41 of the embodiment of the invention is written as “L2” so as to correspond to FIG. 26.

As shown in FIG. 25 and FIG. 26, in the light source 41 of the embodiment of the invention, the lens sheet 21 is arranged in front of the light source 31 (LED 14) of related art having the sealant 51 and the LED semiconductor chip 52.

Accordingly, light emitted from the light source 31 of related art and passing through the lens sheet 21 will be the light from the light source 41 of the embodiment of the invention. The lens sheet 21 has a function of narrowing the directivity of light and increasing the front brightness thereof. In other words, the lens sheet 21 has a function of emitting light by allowing incident light to be close to parallel light.

Therefore, the directivity of light from the light source 41 of the embodiment of the invention is narrowed as compared with the directivity of light from the light source 31 of related art. This is shown in the drawing by the fact that the tear-drop shape indicating the directivity of light from the light source 41 of the embodiment of the invention shown in FIG. 26 is thinner than the ellipse indicating the directivity of light from the light source 31 of related art.

The front brightness L2 of the light source 41 of the embodiment of the invention is increased as compared with the front brightness L1 of the light source 31 of related art. This is shown in the drawing by the fact that the length of a vector (length of an arrow) indicating the front brightness L2 of the embodiment of the invention shown in FIG. 26 is longer than the length of a vector (length of an arrow) indicating the front brightness L1 of the light source 31 of related art in FIG. 25.

The present inventors embodied an example of the light source 41 of embodiment of the invention by arranging the lens sheet 21 whose section is a prism lens shape in front of the light source 31 of related art made of a white LED 14 which is available in the market. Then, the present inventors measured the front brightness L2 of the light source 41 of embodiment of the invention. As a result, it was confirmed that the front brightness L2 of the light source 41 of embodiment of the invention has been at least 1.3 times as the front brightness L1 of the light source 31 of related art, that is, the front brightness L1 obtained when the lens sheet 21 is not arranged in front of the white LED 14.

As described above, the light from the light source 41 of the embodiment of the invention is close to parallel light as compared with the light from the light source 31 of related art.

The operations of the light source 41 of embodiment of the invention can be summarized as follows. Specifically, the light source 31 (LED 14 in related art) of related art can be applied as the light-emitting member. The lens sheet 21 can be applied as the directivity member. In this case, when light emitted from the light-emitting member passes through the directivity member, the directivity of light is narrowed as well as the front brightness is increased. In other words, the light emitted from the light-emitting member is close to parallel light by being passed through the directivity member.

In the above examples, the LEDs 14 of related art (refer to FIG. 22A to FIG. 23D) and the LEDs 14 to which the lens sheet 21 is applied to the resin portion (refer to FIG. 24A to FIG. 24D) are applied as the light emitting member. Also in the above examples, the lens sheet 21 is applied as the directivity member included in the light source of the embodiment of the invention. However, component members of the light source 41 of the embodiment of the invention, namely, any of the light emitting member and the directivity member is not particularly limited to the above examples and various embodiments can be applied. For example, an optional member including a light emitting function such as a lamp can be applied as the light-emitting member. Also, a member having a function of narrowing the directivity of light emitted from the light emitting member and increasing the front brightness, for example, an optional member having a lens function can be applied.

Specifically, it is possible to allow the sealant 51 of the LED 14 to have the lens function. Accordingly, the LED including the LED semiconductor chip 52 as the light emitting member and the sealant 51 having the lens function as the directivity member can be used for the light source 14 of the embodiment of the invention.

FIG. 27 is a perspective view showing an example of the light source 41 of the embodiment of the invention, that is, the light source 41 configured by applying the LED semiconductor chip 52 as the light emitting member and the sealant 51 having the lens function as the directivity member.

More accurately, one of the plural unit light sources included in the light source 41 of the embodiment of the invention is the LED 14 shown in FIG. 27.

In FIG. 27, the z-axis direction indicates a direction in which the light entrance surface 2a of the light guide plate 2 is arranged. The plural unit light sources (LEDs 14) shown in FIG. 27 are arranged in the y-axis direction to constitute the light source 14 of the embodiment of the invention.

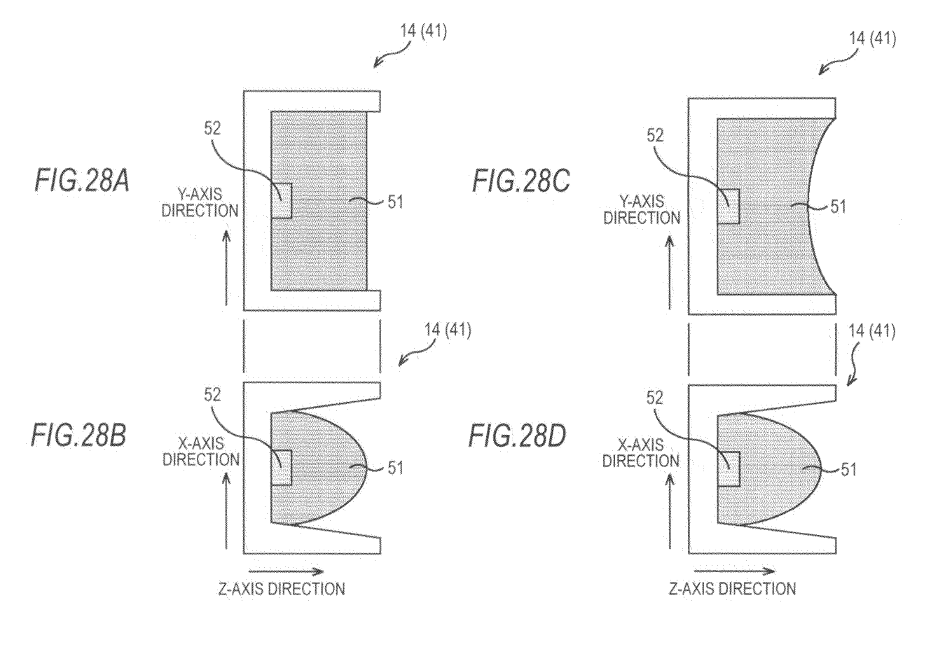

In the example of FIG. 27, the unit light source (LED 14) of the light source 41 of the embodiment of the invention includes the sealant 51 and the LED semiconductor chip 52 (not shown in FIG. 27, refer to FIG. 28A to FIG. 28D). The sealant 51 is formed by, for example, a yellow fluorescent resin, which can exert the lens function by being deformed to a so-called a semi-cylindrical shape.

FIG. 28A to FIG. 28D show cross-sectional views showing side surfaces of the light source 41 of the example of FIG. 26.

FIG. 28A and FIG. 28B show respective cross-sectional views of the side surface in the yz-axis direction and the xz-axis direction of the light source 41 (the LED 14 as the unit light source) of the embodiment of the invention applying the sealant 51 having the so-called semi-cylindrical shape as the directivity member.

The sealant 51 having the so-called semi-cylindrical shape can exert the function of a convex lens with respect to the x-axis direction. As a result, it becomes possible to narrow the directivity of light of the light source 41 in the x-axis direction.

FIG. 28C and FIG. 28D show respective cross-sectional views of the side surface in the yz-axis direction and the xz-axis direction of the light source 41 (the LED 14 as the unit light source) of the embodiment of the invention applying the sealant 51 having the so-called semi-cylindrical shape as well as having a concave lens shape as the directivity member.

Also in this case, the sealant 51 having the so-called semi-cylindrical shape can exert the function of the convex lens with respect to the x-axis direction as shown in FIG. 28D. As a result, it becomes possible to narrow the directivity of light of the light source 41 in the x-axis direction.

Moreover, the sealant 51 having the concave lens shape can exert the effect of the concave lens with respect to the y-axis direction. As a result, the directivity of light of the light source 41 in the y-axis direction can be increased. Light entering from the plural unit light sources included in the light source 41 into the light guide plate 2 is brightened particularly in the vicinity of the center of each unit light source, therefore, unevenness of light sometimes occur. Accordingly, the directivity of light of the light source 41 in the y-axis direction is increased to disperse light in the y-axis direction, thereby reducing the unevenness of light.

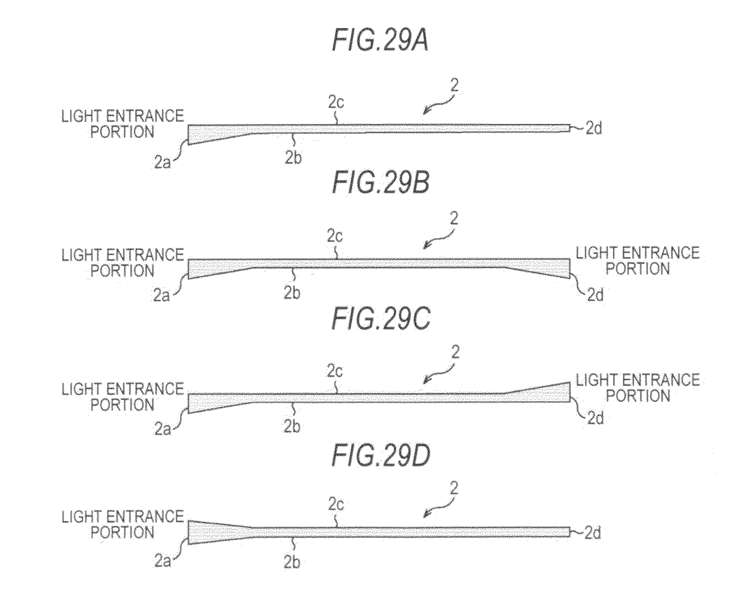

Various examples of the light source 41 of the embodiment of the invention have been explained as the above. A destination to which the light source 41 of the embodiment of the invention is applied, namely, the backlight is not limited to the above examples and various embodiments can be taken. Particularly, there exist various examples in the shape of the trumpet portion of the light guide plate 2 as shown in FIG. 29A to FIG. 29D.

FIG. 29A to FIG. 29D are cross-sectional views showing respective light guide plates 2 including various shapes of the trumpet portions.

In the light guide plate 2 shown in FIG. 29A, there exists only one light entrance portion on the side surface 2a side, and the trumpet portion is provided at the lower surface 2b on the side surface 2a side. That is, the shape of the light entrance plate 2 shown in FIG. 29A is the same as shape of FIG. 3B.

In the light guide plate 2 shown in FIG. 29B, there exist two light entrance portions on the side surface 2a side and the side surface 2d side, therefore, the trumpet portions are provided at the lower surface 2b on the side surface 2a side and the side surface 2d side.

In the light guide plate 2 shown in FIG. 29C, there exist two light entrance portions on the side surface 2a side and the side surface 2d side, therefore, the trumpet portions are provided at the lower surface 2b on the side surface 2a side and at the upper surface 2c on the side surface 2d side.

In the light guide plate 2 shown in FIG. 29D, there exists only one light entrance portion on the side surface 2a side, and the trumpet portions are provided at both the lower surface 2b and the upper surface 2c on the side surface 2a side.

The light source 41 of the embodiment of the invention which has been described above is applied to the backlight, thereby taking the difference of thicknesses between the body portion and the light entrance portion of the light guide plate 2. That is, it becomes possible to set the trumpet angle θ of the light guide plate 2 to be larger or setting the length “L” of the trumpet portion to be longer by applying the light source 41 of the embodiment of the invention. As a result, for example, the following first advantage and the second advantage can be obtained.

The first advantage is that the body portion of the light guide portion 2 can be further thinner, thereby allowing the backlight to be thinner as well as allowing the liquid crystal display device to be lighter in weight and thinner in thickness.

The second advantage is as follows. That is, the light entrance surface 2a of the light guide plate 2 can be made thick, therefore, the light emitting member having the large size, for example, the LED 14 can be applied so as to correspond to the thickness. For example, assume that the same LED semiconductor chip 52 is put into LED packages of 0.3 mm and 0.8 mm respectively to constitute the LEDs 14. In that case, luminance obtained when put into the LED package of 0.8 mm is larger than luminance obtained when put into the LED package of 0.3 mm by 40% to 50%. Accordingly, the light emitting portion having the large size, for example, the LED 14 is applied to thereby realize improvement of luminance and the reduction of luminance deterioration at the display unit of the liquid crystal display. Such is the second advantage.

As described above, the liquid crystal display device has been explained as the display device to which the light source 41 of the embodiment of the invention is applied. The light source 41 of the embodiment of the invention can be applied to not only the liquid crystal display device but also all display devices which display images using the backlight.

The display device using the light source 41 of the embodiment of the invention can be also applied to various electronic apparatuses. As electronic apparatuses, for example, a digital still camera, a digital video camera, a notebook personal computer, a portable phone, a television receiver and the like can be cited. The display device can be applied to displays of electronic apparatuses in various fields, which display video signals inputted to such electronic apparatuses or generated in such electronic apparatuses as images or video. Examples of electronic apparatuses to which the display device is applied will be shown below.

For example, the invention can be applied to a television receiver as an example of the electronic apparatus. The television receiver has a video display screen including a front panel, a filter glass and the like, and manufactured by using the display device according to the embodiment of the invention as the video display screen.

For example, the invention can be applied to a digital still camera as an example of the electronic apparatus. The digital still camera includes an imaging lens, a display unit, a control switch, a menu switch, a shutter and the like, and manufactured by using the display device according to the embodiment of the invention as the display unit.

For example, the invention can be applied to a notebook personal computer as an example of the electronic apparatus. The notebook personal computer includes a keyboard operated when inputting characters and the like in the main body thereof and a display unit displaying images in a main-body cover. The notebook computer is manufactured by using the display device according to the embodiment of the invention as the display unit.

For example, the invention can be applied to a portable terminal device as an example of the electronic apparatus. The portable terminal device has an upper casing and a lower casing. There are a state in which these two casings are open and a state in which these are closed as the state of the portable terminal device. The portable terminal device includes a connection portion (hinge portion in this case), a display, a sub-display, a picture light, a camera and the like, in addition to the above upper casing and the lower casing, which is manufactured by using the display device according to the embodiment of the invention as the display or the sub-display.

For example, the invention can be applied to a digital video camera as an example of the electronic apparatus. The digital video camera includes a body portion, a lens for imaging a subject on a side surface facing the front, a start/stop switch at the time of imaging, a monitor and the like, which is manufactured by using the display device according to the embodiment of the invention as the monitor.

The embodiment of the invention is not limited to the above embodiment and can be variously modified in a range not departing from the gist thereof.

The present application contains subject matter related to that disclosed in Japanese Priority Patent Application JP 2009-007222 filed in the Japan Patent Office on Jan. 16, 2009, the entire contents of which is hereby incorporated by reference.

What is claimed is:

1. A planar light-emitting device comprising:
a light source; and
a light guide member propagating light from the light source,
wherein the light guide member is formed so that a light entrance portion on which light from the light source is incident is thicker than a body portion, and
the light source includes a light-emitting member and a directivity member narrowing the directivity of light emitted from the light emitting member and allowing the light to be incident on the light entrance portion of the light guide member.

2. The planar light-emitting device according to claim 1,
wherein the directivity member of the light source has a lens function.

3. The planar light-emitting device according to claim 2,
wherein the lens function is a function of a convex lens or a prism lens.

4. The planar light-emitting device according to claim 1,
wherein the light source includes an LED (Light Emitting Diode),
an LED semiconductor chip of the LED is included as the light-emitting member, and
component members other than the LED semiconductor chip of the LED constitute the directivity member.

5. A panel comprising:
a backlight including a light source and a light guide member propagating light from the light source; and
a display unit displaying images by using light incident from the backlight,
wherein the light guide member is formed so that a light entrance portion on which light from the light source is incident is thicker than a body portion,
the light source includes a light-emitting member and a directivity member narrowing the directivity of light emitted from the light emitting member and allowing the light to be incident on the light entrance portion of the light guide member.

6. A display device comprising:
a backlight including a light source and a light guide member propagating light from the light source; and
a panel including a display unit displaying images by using light incident from the backlight,
wherein the light guide member is formed so that a light entrance portion on which light from the light source is incident is thicker than a body portion,
the light source includes a light-emitting member and a directivity member narrowing the directivity of light emitted from the light emitting member and allowing the light to be incident on the light entrance portion of the light guide member.
